(19) United States
(12) Patent Application Publication
(10) Pub. No.: US 2024/0320670 A1
(43) Pub. Date: Sep. 26, 2024

(54) DIRECT-SCAN CASH AND DIGITAL ASSET-MANAGEMENT SYSTEMS AND METHODS

(71) Applicant: CashGenius, Inc., Beaverton, OR (US)

(72) Inventors: Christian Saucier, West Union, OR (US); Allison Vagner, Encintas, CA (US); Ethelind Mizar, Beaverton, OR (US); Dale Hunt, Escondido, CA (US)

(21) Appl. No.: 18/579,046

(22) PCT Filed: Jul. 14, 2022
(86) PCT No.: PCT/US2022/073745

§ 371 Date: Jan. 12, 2024

Related U.S. Application Data
(60) Provisional application No. 63/221,685, filed on Jul. 14, 2021.

(51) Int. Cl. G06Q 20/40; G06Q 20/36

(52) U.S. Cl. CPC G06Q 20/401; G06Q 20/36

(57) ABSTRACT

The invention provided herein generally relates to devices, systems, and methods for handling assets having value, including cash and non-cash assets, via digitizing the asset, in such a way as to substantially eliminate employee theft, error, or difficulties in reconciling a record of transactions with a total amount of money in a cash drawer or in a device. The invention allows for transactions involving the digitized asset and/or the value of the digitized asset. The invention also provides devices, systems, and methods for asset-collateralized or cash-collateralized electronic banking.

### CLAIM OF PRIORITY UNDER 35 U.S.C. § 119

The present application for patent claims priority Provisional Application No. 63/221,685 entitled “DIRECT-SCAN CASH-AND DIGITAL ASSET-MANAGEMENT SYSTEMS AND METHODS” filed on Jul. 14, 2021 and assigned to the assignee hereof and hereby expressly incorporated by reference herein.

### BACKGROUND

Certain industries and commercial settings are more cash-intensive than others. In fact, some industries are exclusively cash-oriented, or nearly so. This includes, for example, aspects of the cannabis industry, based on the lack of convenient banking systems and conventions due to ongoing differences between federal and state law concerning cannabis. In addition, many other businesses and industries involve significant use of cash, including casinos, convenience stores, fast food restaurants, festivals, carnivals, fairs, and the like.

Use of cash is a frequent source of difficulties and provides opportunities for theft or costly mistakes. One major problem is that a business owner often has to hire people that he or she does not know well and has to place more trust in such employees to handle cash than may be merited. Some of the solutions for this security problem have been to place cameras directly above the cash-handling space in a business and to have very strict regulations regarding balancing cash drawers. Even in its best form, these approaches require significant effort in counting and sometimes recounting and adjusting for or accounting for errors in the differences between the amount of money in the cash drawer and the total tally for the day. These processes introduce numerous additional opportunities for mistake and fraud.

Because of their similitude with cash, digital assets are becoming more prevalent in these same industries. Digital assets are also becoming more prevalent as users increasingly choose to conduct certain financial transactions on platforms which are not necessarily facilitated by traditional banks, banking devices, and accounting systems. This includes buying, selling, and using cryptocurrency, allowing transactions to be conducted regardless of hard currency. There is also a need to conduct financial transactions using non-cash assets which have value, such as vehicles, real estate, art, non-fungible tokens (NFTs), and the like. Traditional banks, banking devices, and accounting systems do not allow for such transactions.

### SUMMARY OF THE INVENTION

Embodiments of the present invention relate to asset-management systems that provide on-location cryptographically secure asset digitization, adapted for handling of one or more items of at least one asset type, the system including: a user interface; an intake portal adapted to: a) receive documented evidence of one or more assets, and b) capture or assign a unique identifier for the asset; a processor adapted to receive, process, and transmit said asset unique identifier; a cryptographically secure immutable digital asset ledger for storing documented evidence of the asset; and a means of providing a cryptographically unique proof of record.

In some embodiments, the asset can include one or more of currency, digital currency, non-fungible tokens (NFTs), legal instruments (e.g. title to any tangible or intangible asset such as real estate, motor vehicles such as cars or boats), stocks, bonds, intellectual property (e.g. patents, trade secrets), art, tickets, coupons, tokens (such as casino tokens), notes, banking accounts, digital currency wallets, contracts, promissory notes, private keys, public keys, or any item with documentable value.

In some embodiments, the asset can be self-validating (has an accepted value). In some embodiments, the asset may not be self-validating (e.g. wherein the asset includes title) and wherein documented evidence of the asset includes more than one form of documentation for verification of a user and/or the asset. In some embodiments, the documented asset evidence can include one or more selected from physical identification, biometric data, witness evidence, multimedia evidence, bank statements, legal documents, chain of title and/or provenance, reputation score, and/or any physical documentation relating to the user and/or the asset.

In some embodiments, the user interface and the intake portal can be present on a single device. In some embodiments, the user interface and the intake portal can be present on separate devices. In some embodiments, the user interface can be implemented by an interaction between a machine and a user. In some embodiments, the user interface can include an app for a mobile device, a camera, a screen, a computer program, or a physical key.

In some embodiments, the intake portal can include one or more types of document imaging technology to provide the system with documented evidence of an asset. In some embodiments, the intake portal can include a scanner. In some embodiments, the intake portal can capture the unique identifier present on the asset if the asset is self-validating, or creates a new unique identifier if the asset is not self-validating.

In some embodiments, the processor can cryptographically secure the documented evidence captured by the intake portal by generating the unique digital signature of the evidence using a hashing function. In some embodiments, the output of the hashing function can be posted to an immutable digital asset ledger, thereby securing the integrity of the documented evidence received by the input portal.

In some embodiments, the asset unique identifier can be saved locally and on the immutable digital asset ledger. In some embodiments, the immutable digital asset ledger can include a system inventory of multiple asset items present in the system. In some embodiments, the asset unique identifier can include the item's value denomination.

In some embodiments, the asset is not currency. In some embodiments, at least one of the asset types is not currency.

In some embodiments of the invention, the system further includes a physical or digital wallet storing the cryptographically unique proof of record.

In some embodiments, the asset unique identifier can be unique to each asset item within an asset type, such that each asset item of a given asset type is distinguishable from every other item of said asset type.

In some embodiments, the system can provide on-location cryptographic validation of a digital asset, wherein the system recognizes an immutable ledger in which the digital asset is registered and uses the ledger of record to validate the authenticity of the digital asset.

In some embodiments, the digital asset can be subject to a valuation discount factor. In some embodiments, the valuation discount factor can be based on at least one of asset type, strength and/or quality of evidence, reputation of the user, or network appraisal.

In some embodiments, the system can provide on-location cryptographically secure exchange of assets. In some embodiments, exchange of assets involves a user exchanging assets from one type to another. In some embodiments, exchange of assets involves a user exchanging assets to another individual.

Further embodiments of the invention relate to an asset inventory system or asset digital repository system employing any of the features described above.

Further embodiments of the invention relate to an asset exchange system employing any of the features described above.

Further embodiments of the invention relate to an asset-collateralized banking system, including any of the features described above.

Further embodiments of the invention relate to systems as described above and further including a sorter adapted to sort each item of asset input into one of a plurality of primary asset stores, wherein each primary asset store corresponds to an asset type, such that after handling by the sorter each item of asset input is placed in a selected primary asset store according to the asset type of said item of asset input, wherein the primary asset store for a type of physical currency corresponds to the value denomination.

Certain embodiments relate to devices and solutions for handling cash or quasi-cash items, and other assets, such as digital assets, in such a way as to substantially eliminate employee theft, error, or difficulties in reconciling a record of transactions with a total amount of money in a cash drawer. Embodiments of the invention provide cash drawers that are secure, cannot be opened manually, and have one point of entry. At the point of entry, or intake portal, embodiments of the invention provide a scanner capable of scanning every item to capture its unique identifier and its value. Optional scanning can also test for whether the currency is counterfeit. In some cryptocurrency networks, such as, for example, Bitcoin, the device can immediately validate the legitimacy of the intake of value; this functionality can be offered in both online and offline modes based on the device embodiment.

Advantages of keeping track of unique identifiers include: (1) creating a record of what exactly is in the system and within each collection of cash items either in “Dynamic Storage Package” (DSP, or “bundle”) or in a “Static Storage Package” (SSP, or “brick”) recorded in the system, (2) making each brick transferrable and fraud-resistant, (3) enabling banking-like functionality because the cash is safe collateral and not fungible, (4) preventing counterfeits, because each scanned item is unique and duplicates can be identified. In some embodiments, the system gives each item a unique identity from scanning the identifier located on or within the physical item. Thus, even if the physical cash is stolen, the record of item's identity can be provided to law enforcement and the items can be more easily located and returned. Digital assets are similarly uniquely identified with the added security of having the asset identity and control keys recorded in a digital network.

A complete record of every asset item entering the system is made by communicating the scan data for each item into a spreadsheet, database, or like computer system for organizing data (the data manager). A system inventory within the data manager retains records of all items, bricks, bundles, digital asset tokens, and transactions. In addition, accounting may be done in real time either within the cash-management system through internal functions or through integration with commercial accounting software. Optionally, change can be made by having an exit/output function as part of the primary repository. The output is only triggered after an input of an amount of currency that is in excess of the amount of the transaction. In the event that the change required is a fraction of a currency unit (the units being, e.g., dollars, and the fractions being, e.g., cents), additional output functionality can be provided. In an embodiment, an automatic coin dispenser controlled by the data manager counts the coins and dispenses correct change. The transaction is not complete until money is entered into the cash drawer and any change is given. Real-time accounting for money entering or leaving the cash-management system is accomplished through communication between the intake portal, the output function, and the data manager.

Digital assets can be stored as either fungible or non-fungible assets; for example, fungible assets can be stored in common as a balance of value under an account number, whereas non-fungible assets are held uniquely and cannot be sub-divided in smaller units. Bitcoin is a fungible asset; a collectible sword in a virtual world is a non-fungible asset; both digital assets could be offered as input to some embodiments.

Embodiments of the invention reduces opportunities for human error or fraud. In some embodiments, the cash-management system also is capable of packaging like asset items into packages containing a set number of bills, further facilitating handling of cash. In further optional embodiments the cash-management system can feed directly into a safe or vault or other secured storage area. Similarly, the keys to a digital asset can be packaged together and protected by other features such as a password, proof of identity, access certificates, and other forms of cryptographic security.

In practice, a cash transaction involves, for example, entering a total transaction amount into a cash register or like device in the cash-management system of the present invention; or a calculation of a total transaction amount derived from one or more purchase decisions entered into an interactive user interface; or the like. A buyer provides cash in an amount that is equal to or greater than the transaction amount. In some embodiments, this cash is provided to a cashier, who inserts the cash into the point of entry. In other embodiments, the buyer provides the cash directly to the point of entry. Embodiments with digital asset support can allow payment using crypto-currencies and digital assets; digital assets are entered in the device by scanning, or otherwise providing access to the ownership keys to the digital asset. Another form of digital asset key entry includes providing a recovery seed phrase. The point of entry scans each item to capture its unique identifier and value. A record of total cash in the cash-management system, as well as a record of all item identifiers contained within the cash-management system, is maintained in the data manager, and updated in real time. In the event that the amount of cash entered into the cash-management system is greater than the transaction amount, change is provided by dispensing currency from the cash-management system through a dispensing slot that scans the currency leaving the cash-management system. The data manager reconciles not only the total amount of cash remaining in the cash-management system, but also the individual identity of items entering and leaving the cash-management system, such that the data manager provides both an accurate total of the amount of money in the cash-management system, and an inventory record of each individual asset item. In alternative embodiments, the system does not deal with change, has only a limited pool of change, or rounds purchases to the nearest dollar (or other unit of currency) and provides the remainder to charities or other recipients.

The cash-management system can be linked to a permanent record-keeping system such as, e.g., a blockchain, to further reduce or eliminate risk of or opportunities for fraud in handling cash in the cash-management system. Linkage of data systems to blockchain systems is known within the art and is within the capability of a person practicing the invention.

Embodiments of the invention are particularly useful in cash-intensive businesses and functions such as the cannabis industry. The invention can also find great utility and acceptance in any other industry involving the handling of cash. The invention simplifies the handling and tracking of cash by directly creating an inventory of asset items and a total cash value, and by optionally screening for counterfeit currency. This eliminates the need for additional levels of accounting, processes such as drawer-balancing or currency counting, and the security required when cash can be diverted from a transaction in an act of theft, fraud, carelessness, or simple human error. The invention can be used in any business that uses cash, for example, fast food restaurants, convenience stores, casinos, carnivals/fairs, etc. Embodiments of the invention are particularly beneficial in industries that are not permitted to participate in a conventional banking system, by permitting an all-cash financial system that is accurate, secure, and compatible with electronic transactions collateralized by tangible cash reserves. Embodiments that include digital asset functionality provide a convenient means for cash-intensive businesses to begin accepting cryptocurrencies, digital tokens, and a multitude of valued non-fungible assets as forms of payment.

Embodiments of the invention relate to a system that provides on-location cryptographically secure asset digitization, comprising an asset-management system adapted for handling of multiple items of at least one asset type. The asset can be one or more type of physical currency, item of intellectual property, trade secret, note, contract, creative work, private key, and/or public key wherein the physical currency of each type can have a plurality of predetermined value denominations. The asset item can further include a unique identifier, wherein said unique identifier is unique to each asset item within an asset type, such that each asset item of a given asset type is distinguishable from every other item of said asset type. The system can include a user-interface stage. The user-interface stage can include an intake portal adapted to receive asset inputs from a user, wherein the intake portal can include a scanner capable of capturing item data from an item of intake; wherein the item data can include the item's unique identifier and the item's value denomination. The system can further include a processor adapted to receive, process, and transmit item data to a system record, wherein the system record can include a system inventory of all asset items present in the system. The system can further include a sorter adapted to sort each item of asset input into one of a plurality of primary asset stores, wherein each primary asset store corresponds to an asset type, such that after handling by the sorter each item of asset input can be placed in a selected primary asset store according to the asset type of said item of asset input, wherein the primary asset store for a type of physical currency corresponds to the value denomination.

In some embodiments, the system provides on-location cryptographic verification of a digital asset, wherein the system recognizes a network in which the digital asset is registered and can use an embedded copy of the network's digital asset ledger or rely on an online copy to validate the authenticity of the digital asset. In some embodiments, a public key representing a tokenized asset can be accepted as a document in the intake portal. In some embodiments, the digital asset network provides a valuation estimate.

In some embodiments, the system provides on-location cryptographically secure exchange of assets, wherein a digital asset entered into the system can be transferred to a DSP, and wherein ownership of a digital asset can be transferred by providing a private key belonging to an owner of the digital asset and a public key belonging to a recipient of the digital asset, wherein the private key and the public key are entered into the system using the intake portal.

In some embodiments, the user-interface stage can further include an output portal adapted to return output assets to a user. The output portal can include a scanner capable of capturing item data from an item of output assets, such that output assets are removed from the system inventory. The system can include a retriever adapted to retrieve a predetermined number of one or more denominations of assets from the appropriate primary asset stores to deliver the output assets through the output portal to the user. The asset can be a physical or digital asset and can include an item of intellectual property, trade secret, note, contract, creative work, and/or private key, any of which can be in the form of a document with a digital representation of the asset in the intake portal and/or the output portal.

In some embodiments, the intake portal and the output portal are the same, such that a single portal can be capable of fulfilling both intake and output functions.

In some embodiments, the asset items can further include indicia of an asset type, and the scanning, sorting, and record functions of the system can be adapted to handle currencies of a plurality of asset types.

In some embodiments, the plurality of asset types can correspond to plurality of national issuers of assets, and the primary asset stores can comprise a separate primary asset store for each value denomination within each asset type. In some embodiments supporting digital assets, fair market value can be assessed using user-selected exchanges, enabling input and output of digital assets, and providing the user with a fair market value balance denominated in a user-selected asset.

In some embodiments, the system can further include a dynamic asset storage stage in physical communication with the user-interface stage. The physical communication between the stages can include a dynamic packaging interstage. The dynamic packaging interstage can be adapted to select a predetermined number of asset items of like value denomination from a primary asset store and package the predetermined number of items in a dynamic storage package (DSP), each DSP having an assigned dynamic storage package identifier (DSP Identifier) unique to the DSP, and each DSP having a predetermined total asset value based upon the predetermined number and the value denomination of the DSP. The dynamic interstage can be further adapted to deposit each DSP, after packaging, into the dynamic asset storage stage. In connection with packaging and deposit of a DSP, the DSP Identifier can be communicated to the system record, and the DSP Identifier can correspond to a unique DSP sub-inventory of asset items within the system inventory, where the DSP sub-inventory is a subset of the system inventory. After the scanning process, an asset scanned as a document with a digital representation of the asset can be tokenized in the device, and the tokenized asset can be signed digitally into a DSP.

In some embodiments, the system can generate and distribute cryptographic keys representing ownership of a DSP. This process is known within the industry as “tokenization”. Having tokenized a DSP, some embodiments can publish contracts for ownership rights of the content of the DSP. In some embodiments, the system supports integration with user-selected digital asset marketplaces to facilitate establishment of a fair market value for selected tokenized DSP.

In some embodiments, the dynamic packaging interstage can also include retrieval capability to retrieve a DSP and depackage the DSP and deliver assets from the depackaged DSP back to a primary asset store, or deliver the entire DSP to a user via a DSP-output in the user interface stage. In embodiments with digital assets capabilities, depackaging a tokenized DSP requires owner approval in the form of a digital signature from the token key holder.

In some embodiments, upon depackaging, the DSP identifier can be removed from the system record and the unique identifiers are no longer associated with a DSP through a DSP identifier.

In some embodiments, the DSP identifier can be recorded as exiting the system and all associated unique identifiers are removed from the system inventory.

In some embodiments, the system can further include a payout ledger of DSPs or individual asset items outputted from the user interface stage.

In some embodiments, the dynamic asset storage stage can further include a banking deposit function, where multiple DSPs can be withdrawn directly from a portal in the dynamic asset storage stage in preparation for a bank deposit or other use of the assets within the DSPs.

In some embodiments, the DSP Identifiers and sub-inventories can be communicated to the bank and recorded in the system record as having been withdrawn from the system inventory for bank deposit.

In some embodiments, the system can further include a static packaging interstage. The static packaging interstage can be adapted to receive multiple DSPs and package them into a secure container as a static storage package (SSP) for containing assets.

In some embodiments, the SSP is adapted to be tamperproof, fireproof, waterproof, EMP-proof, location-trackable, and/or the like, and/or any combination thereof. In some embodiments, the SSP can include a unique static storage package identifier (SSPID). In some embodiments, the SSP can contain a total amount of assets equaling a predetermined value.

In some embodiments, the SSP can include an unlock code required for opening the SSP. In some embodiments, the unlock code can be executable from a remote location. In some embodiments, the unlock code can function in an unlocking device adapted to unlock the SSP. In some embodiments, the unlock code can function to unlock the SSP only when it is in physical contact with the unlocking device.

In some embodiments, the system further includes a static storage stage for secure storage of multiple SSPs. In some embodiments, the static storage can be adapted for input and output of SSPs via at least one portal. In some embodiments, the at least one portal requires one or more of an access code and a physical key for activation. In some embodiments, the static storage can be adapted to read and report all SSPIDs of SSPs contained therein.

In some embodiments, the cryptographic keys to digital-assets are stored or transferred to user-controlled hardware devices. In some embodiments, the cryptographic keys to digital assets are generated and stored in the brick hardware itself.

In some embodiments, the system can include a sub-inventory of all items contained within the static storage. In some embodiments, the static packaging interstage is integral with the dynamic asset storage stage or with the static storage stage.

In some embodiments, the system can further include a centralized asset storage stage (CASS) adapted to receive SSPs from multiple instances of the system for secure storage of the SSPs, where each instance of the system can be associated with a unique user of the system and/or a unique account within the CASS, where the CASS can be adapted to read and record the SSPID of each SSP associated with any instance of the system and/or with any account within the CASS.

In some embodiments, the CASS can maintain a sub-inventory of the asset contained in each account. In some embodiments, the CASS can be further adapted to permit transactions between or among users of the system.

In some embodiments, each transaction can include a change in an ownership record associated with at least one SSP and/or at least one DSP within a given SSP.

In some embodiments, the transactions can be encrypted and remotely executable.

In some embodiments, information in the system is recorded in a blockchain.

Some embodiments of the invention relate to a cash-inventory system employing any of the features described herein.

Some embodiments of the invention relate to a cash-collateralized banking system, including any of the features described herein.

Some embodiments of the invention relate to a method of cash management. The method can include providing a cash-management system including at least one cash-handling portal comprising scanning capability. The method can include scanning all assets as part of a cash transaction, cash deposit, cash withdrawal, or any combination thereof, to record data relating to each individual asset item, where the data includes data unique to each individual item. The method can include creating a cash inventory record treating each individual asset item as a separate entry. The method can include updating the cash inventory record with each transaction, deposit, withdrawal, or any combination thereof.

Some embodiments of the invention relate to methods of asset management including the steps of: providing an asset-management system comprising at least one asset-handling portal comprising scanning capability; scanning all asset items as part of a transaction, deposit, withdrawal, or any combination thereof, to record data relating to each individual asset item, wherein the data comprises data unique to each individual item; digitizing all asset items; storing the digitized asset items in a digital asset repository; recording the transaction, deposit, withdrawal, or any combination thereof; creating a digital asset inventory record treating each individual digitized asset item as a separate entry; and updating the digital asset inventory record with each transaction, deposit, withdrawal, or combination thereof.

In some embodiments, the digital asset inventory record can be a cryptographically secure immutable digital asset ledger.

In some embodiments, the method can further include sorting asset items into like denomination.

In some embodiments, the method can further include packaging asset items into a dynamic storage package (DSP) having a unique dynamic storage package identifier (DSPID) and having a sub-inventory of currency bundled into the DSP.

In some embodiments, the DSP can be adapted for temporary storage of assets and optional retrieval of assets from the DSP as required for withdrawals, transactions or any combination thereof, and concomitant adjustments to the cash inventory record.

In some embodiments, the method can further include packaging asset items into a static storage package (SSP) having a unique static storage package identifier (SSPID) and having a sub-inventory of assets contained within the SSP.

In some embodiments, the SSP can be adapted for secure storage of assets. The SSP can be tamperproof, fireproof, waterproof, EMP-proof, location-trackable, and/or the like, and/or any combination thereof.

In some embodiments, the method can further include storing separately packaged, uniquely identified, and separately inventoried assets belonging to multiple users in a centralized secure facility.

In some embodiments, the method can further include maintaining an inventory of all assets in the facility where the inventory can associate a user/owner with the inventory record of each asset item.

In some embodiments, the method can further include coordinating transactions between or among users, where the transactions can include updates to the inventory record reflecting a change in ownership of the assets.

### BRIEF DESCRIPTION OF THE DRAWINGS

FIG. 1 shows the first part of a transaction utilizing a cash-management system embodiment of the present invention. Cash 100 is provided to the intake portal 210 of the user interface stage 200. The cash is passed from the intake portal 210 through the scanner 220. The scanner 220 records the value of each asset item, and that data is conveyed to the record of cash value 420 within the data manager 400. The scanner 220 also records the unique identifier of each item and conveys this information to the record of asset items 410. The scanner also optionally provides information to the authenticator 440 which verifies whether each item is counterfeit or legitimate. The physical cash is passed from the user interface stage 200 to the primary repository 300.

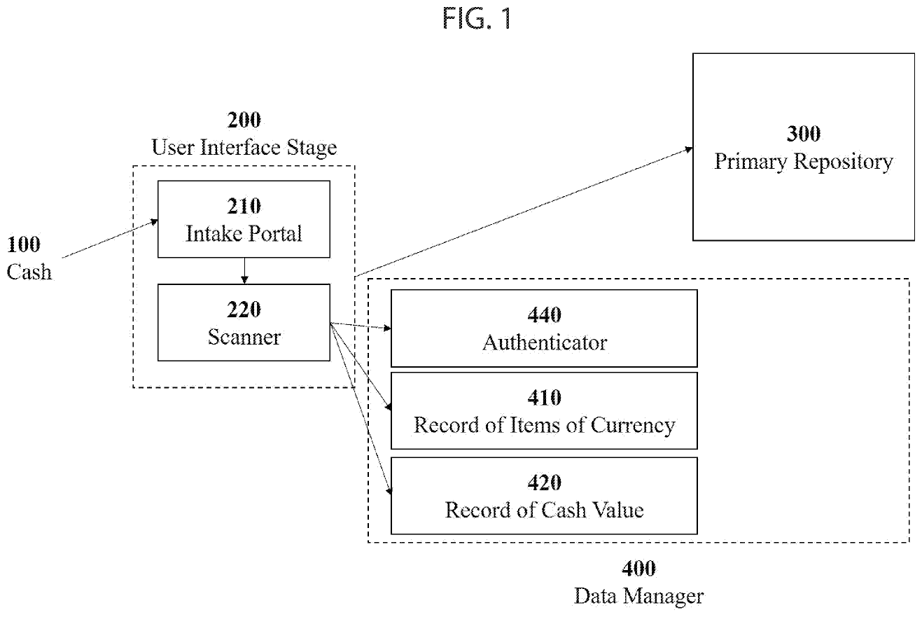

FIG. 2 shows a transaction which requires the making of change. The transaction proceeds as described in FIG. 1. The change calculator 430 determines the proper amount of change to be dispensed. The change calculator 430 communicates to the primary repository 300 the amount to be dispensed. The primary repository 300 provides to the user interface stage 200 the proper amount of cash. The scanner 520 scans each item as it exits the cash-management system and conveys the identity of each leaving item to the record of asset items 410. The change calculator 430 provides information on the amount to be dispensed to the record of cash value 420. The physical cash is then provided to the output portal 510 at the user interface stage 200.

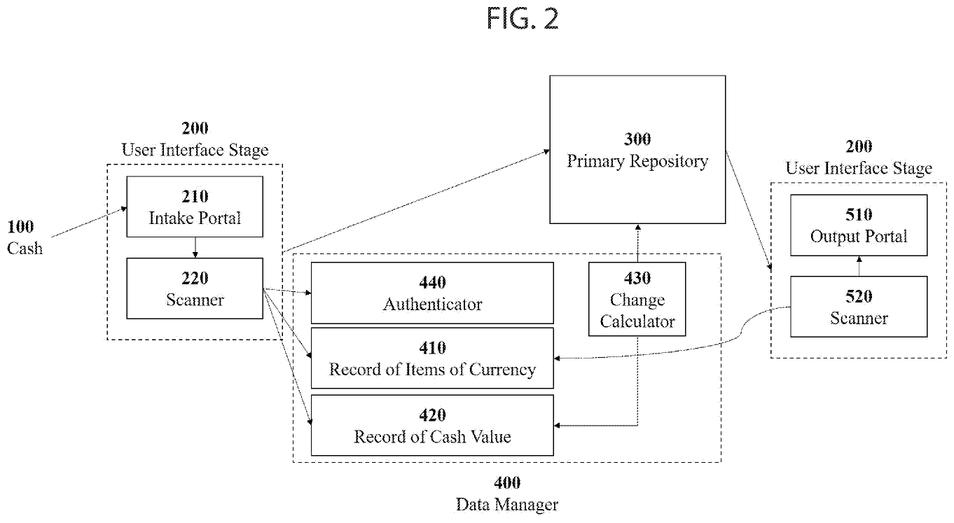

FIG. 3 illustrates movement of the cash from the primary repository 300 to a local secondary repository 600 for optional eventual bank deposit. The bundle manager 450 in the data manager 400 is programmed to create bundles of like asset items in predetermined values. The bundle manager 450 communicates with the record of cash value 420 to determine when the bundling threshold is reached. The bundle manager 450 instructs the primary repository 300 to create the bundle(s). The physical bundles are then passed from the primary repository 300 to a local secondary repository 600. The bundle manager 450 communicates with the record of asset items 410 to collect the identities of each item placed in the bundle. The bundle manager 450 conveys the identity of items within the bundle, a “Dynamic Storage Packet Identifier” (DSPID), and the cash value of the bundle to the bundle inventory 460. The bundles are kept in the local secondary repository 600 until they are optionally moved to a banking institution 700 for deposit, or accessed for transactions supported by the secondary repository, or moved from the secondary repository to Static Secure Storage.

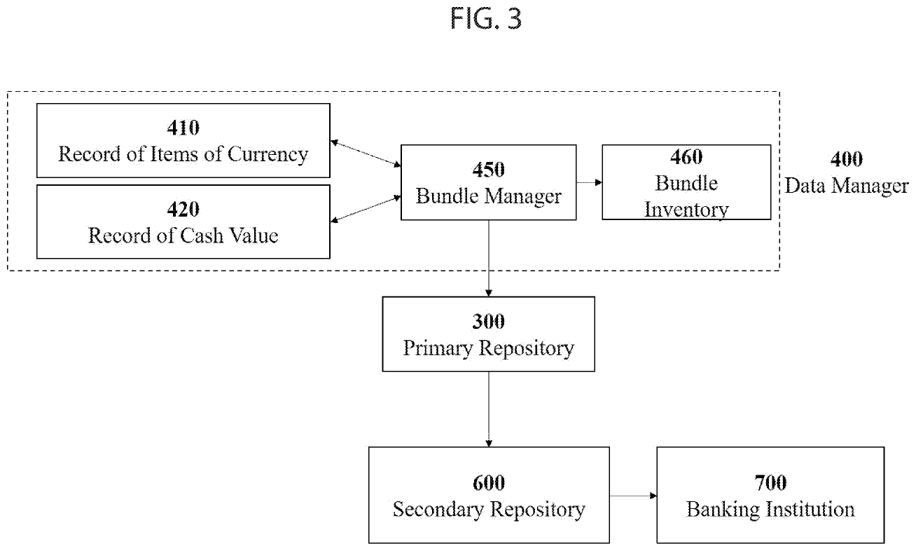

FIG. 4 illustrates movement of the cash from the primary repository 300 to a local secondary repository 600 when deposit with a banking institution is not the end goal. The initial bundling process follows that described in FIG. 3. However, in this embodiment the bundling process is reversible. Bundles may be removed from the local secondary repository 600 into the primary repository 300 and are unbundled either within the secondary repository or within the primary repository or in a bundling/unbundling system operating between the primary repository and the secondary repository. The bundle manager 450 communicates with the primary repository 300 to identify the bundle being unbundled by correlation with the bundle's DSPID. The bundle manager 450 communicates with the bundle inventory 460 to identify the cash value of the bundle and the identities of the items within that bundle. The bundle manager 450 conveys the identity information of the unbundled items to the record of asset items 410. The bundle manager 450 conveys the cash value of the unbundled items to the record of cash value 420. The physical cash is removed from the local secondary repository 600 and passed to the primary repository 300.

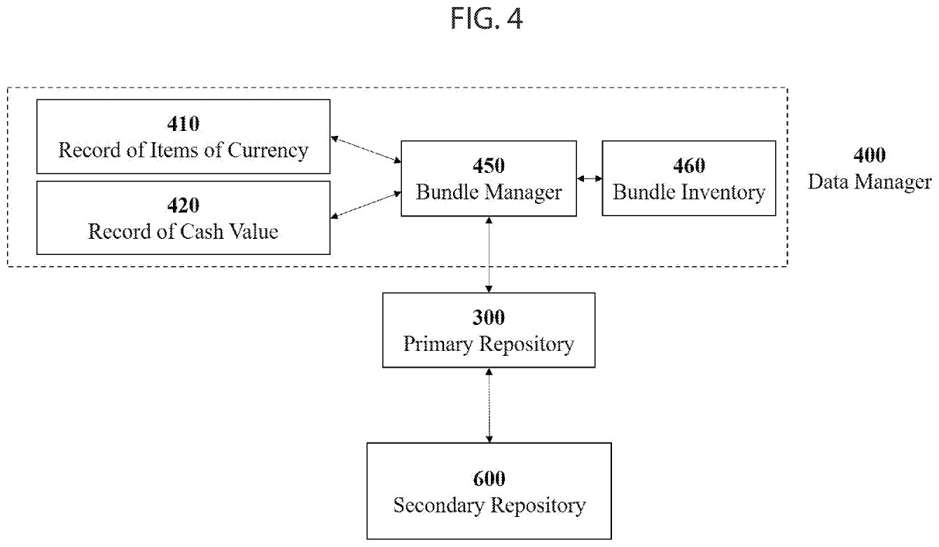

FIG. 5 illustrates a method for long term cash retention within the cash-management system. The brick manager 470 within the data manager 400 is programmed to create bricks of predetermined value from bundles within the local secondary repository 600. The brick manager 470 communicates with the bundle inventory 460 to determine when the brick creation threshold is reached. The brick manager 470 instructs the local secondary repository 600 to create a brick 1000 using bundles identified by their DSPIDs. The physical bricks 1000 can be moved as desired by the user. The brick manager 470 conveys the identity of the bundles in the brick 1000 to the bundle inventory 460 and conveys the identity all items in the brick to the record of asset items 410. The brick manager conveys the total cash value of the brick to the record of cash value 420. The brick manager 470 conveys the identity of items within the brick, an identifying brick signature (“SPID”), a unique brick access code, and the cash value of the brick to the brick inventory 480.

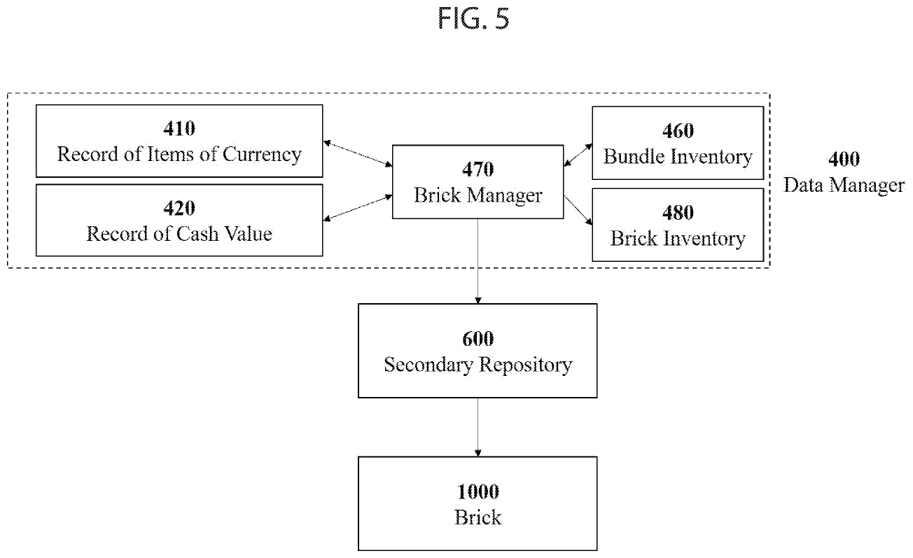

FIG. 6 illustrates a countertop embodiment of the first stage of the invention. A user interface screen 230 is provided to facilitate human use of the invention, such as providing a display of the products involved in the transaction and a transaction price. Cash 100 is inserted into the intake portal 210. The cash is passed to a scanner 220, which scans each asset item for value, unique identifier, and other data. The scanned data is conveyed to the system inventory (not shown). After being scanned, the cash is passed to a secure primary repository 300. Transactions are not completed until data and assets are secured. When change is required, the proper amount of change can be removed from the primary repository 300 and provided to a scanner 520 which scans each asset item to be dispensed as change for value, unique identifier, and other data. This data is conveyed to the system inventory and records are updated as appropriate. The cash is then provided to the user through an output portal 510.

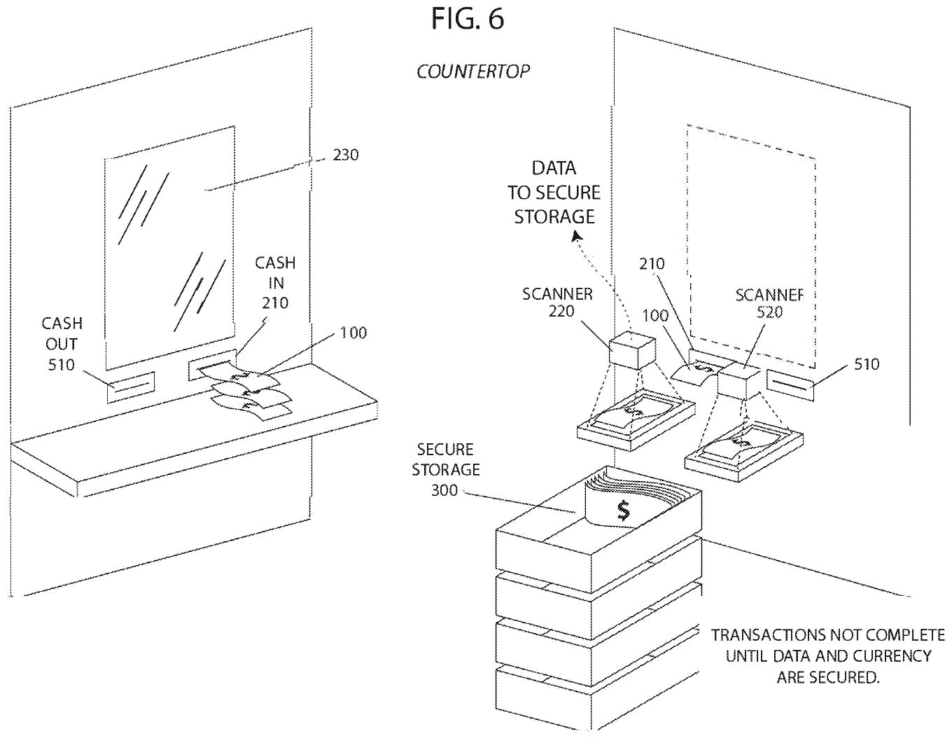

FIG. 7 illustrates the bundling operations which occur below the countertop unit. One or more devices (not shown) are provided which collect cash in the amount to be bundled from the secure primary repository 300. The items within the bundle are recorded, along with the value of the bundle. After packaging, each bundle 610 is assigned a unique bundle identifier recorded in the bundle inventory 460. In some embodiments, the bundles 610 may be retrieved and unbundled to access the items contained within them to fulfill a wide range of business needs.

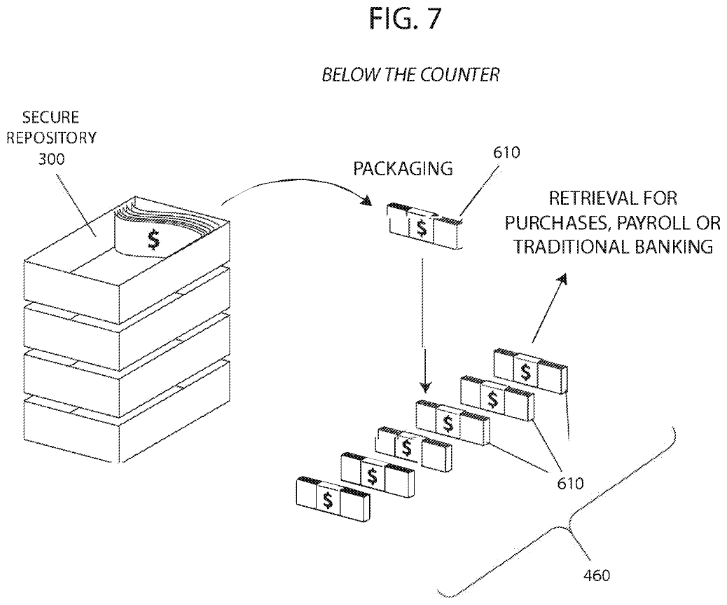

FIG. 8 illustrates the creation of a “Static Storage Package”, or brick 1000. In this embodiment, the brick consists of two rectangular boxes with five sides, i.e., one side of each box is open. Cash is placed within the smaller box. The larger box is then secured over the top of the smaller box, resulting in a single box closed on all sides. The brick packaging may be comprised of a variety of materials and can comprise additional locking or security features. Each brick is assigned a “Static Storage Package ID” (SSPID) which identifies it within the system. The SSPID is associated with records of each bundle and asset item contained in the brick. Each brick is assigned an access key that is required to open the brick and access the cash. Use of the access key destroys the validity of the brick within the system.

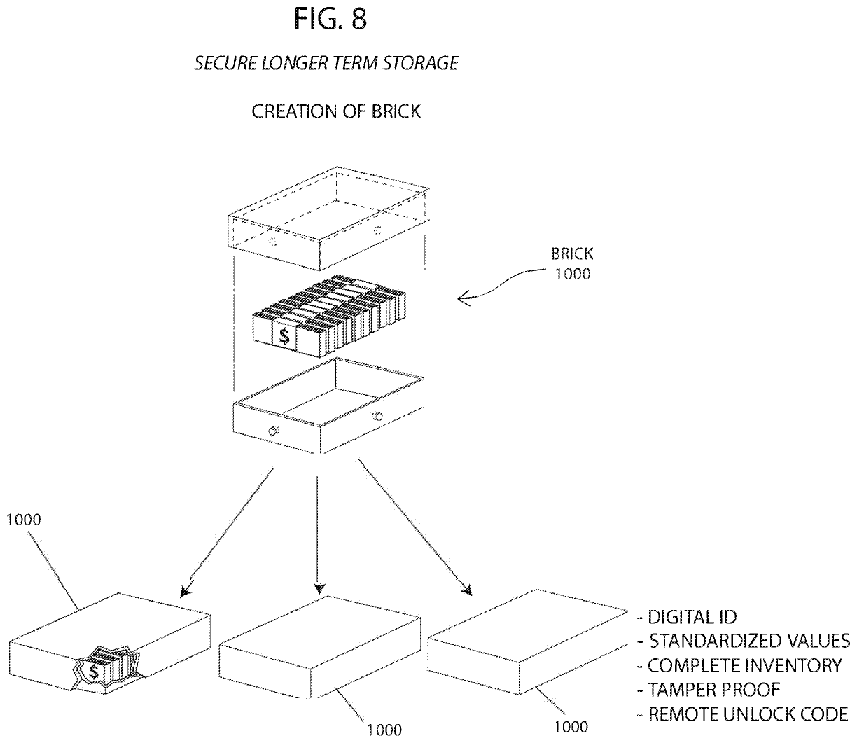

FIG. 9 illustrates the retention of multiple bricks 1000 as an alternative to traditional banking deposit. The physical bricks may reside in any location desired by the user, and title to the cash can be transferred by transfer of the SSPID and access key to one or more bricks.

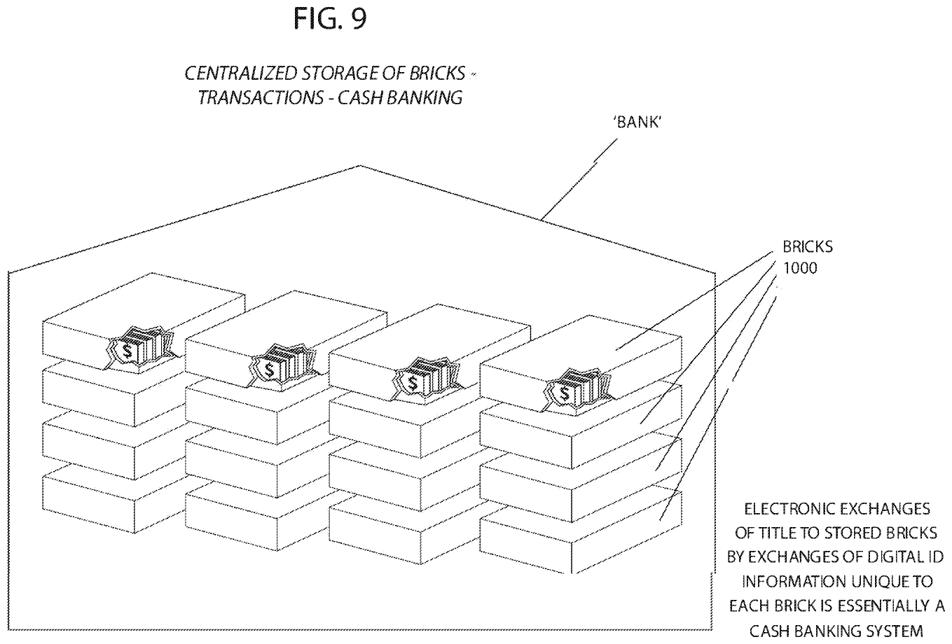

FIG. 10 illustrates an exemplary embodiment of the invention wherein the system of the present invention enables a user to input an asset, or some form of documentation of an asset, into the system. As shown in FIG. 10, the asset is a physical asset, but the asset can be the asset itself (such as cash), some form of documentation of an asset (such as a document like a car title, if the asset is a car), some form of documentation of a digital asset (such as a token, key, QR code, etc), or the like. The asset is received by the system, which stores the asset and digitizes the asset. The system then provides a transaction receipt to the user, which has keys allowing the user to demonstrate ownership of and access the digitized asset held by the system.

FIG. 11 illustrates a further exemplary embodiment of the invention wherein, as in FIG. 10, the user inputs an asset, or some form of documentation of an asset, into the system, which stores and digitizes the asset, and provides a transaction receipt to the user, including keys allowing the user to demonstrate ownership of and access the digitized asset held by the system. The transaction can be recorded on a blockchain. The asset optionally can then be held internally by the system or can be physically transferred out of the system to another location, which can be onsite or offsite at another location. The digitized asset can then be communicated to a third-party marketplace or auction house for resale. Buyers can review, purchase, or bid on the digitized asset via the third-party auction house or marketplace. The purchaser or winning bidder then makes payment for and receives the asset, after which time the payment is verified and conveys to the user who originally input the asset. Upon receipt and acceptance of payment, the user has the payment, and the ownership of the asset is now with the buyer, and evidence of the new ownership can be recorded on the blockchain.

FIG. 12 illustrates a further exemplary embodiment of the invention wherein, as in FIG. 10, the user inputs an asset, or some form of documentation of an asset, into the system, which stores and digitizes the asset, and provides a transaction receipt to the user, including keys allowing the user to demonstrate ownership of and access the digitized asset held by the system. The transaction can be recorded on a blockchain. The asset can then be digitized into a non-fungible token (NFT) and placed into a digital asset repository (i.e., a vault of crypto keys). The asset optionally can then be held internally by the system or can be physically transferred out of the system to the owner of the digital asset repository or crypto keys vault, which can be onsite or offsite at another location. The owner of the vault or digital asset repository then makes payment for the asset, after which time the payment is verified and conveys to the user who originally input the asset. Upon receipt and acceptance of payment, the user has the payment, and the ownership of the asset is now with the owner of the vault or digital asset repository, and evidence of the new ownership can be recorded on the blockchain.

FIG. 13 illustrates a further exemplary embodiment of the invention wherein, as in FIG. 10, the user inputs an asset, or some form of documentation of an asset, into the system, which stores and digitizes the asset, and provides a transaction receipt to the user, including keys allowing the user to demonstrate ownership of and access the digitized asset held by the system. The transaction can be recorded on a blockchain. The asset can then be digitized into an NFT and placed into a digital asset repository (i.e., a vault of crypto keys). The asset optionally can then be held internally by the system or can be physically transferred out of the system to another location, which can be onsite or offsite at another location. The owner of the digital asset repository or crypto keys vault then reviews the asset and conducts offline curation and selection, which can include valuation, pricing, authentication, and various steps to establish the provenance and/or pricing and/or marketing strategy for the asset. The owner of the digital asset repository or crypto keys vault then can communicate the digitized asset to a third-party marketplace or auction house for resale. Buyers can review, purchase, or bid on the digitized asset via the third-party auction house or marketplace. The purchaser or winning bidder then makes payment for and receives the asset, after which time the payment is verified and conveys to the user who originally input the asset. Upon receipt and acceptance of payment, user has the payment, and the ownership of the asset is now with the buyer, and evidence of the new ownership can be recorded on the blockchain.

### DETAILED DESCRIPTION OF THE INVENTION

As used herein, “cash” refers to physical monetary instruments, embodied in bills, coins, and/or the like. Cash is inclusive of such physical monetary instruments as may be issued by any national or international authority. Cash is also inclusive of quasi-monetary instruments, such as casino chips or physical instruments backed by digital assets or cryptocurrencies, as may be issued by any entity. Each of said individual physical monetary instruments is known as an “asset item”. Items can be classified based upon type of physical embodiment, national issuer, and/or the like. Each item carries a value denomination, and can further carry identifying indicia, such as serial numbers, embedded RFID signatures, and/or the like. In combination, these characteristics represent a data profile for each monetary instrument. For example, a United States one-dollar bill can have a data profile as follows:
Type: United States Bill
National Issuer: United States
Value Denomination: 1 United States Dollar
Serial Number: E19066540H

The terms “asset” and “assets”, as used herein, relate to one or more items having a value. The assets can be physical assets, such as currency or cash, or digital assets, or any item with documentable value. For example, an asset can include one or more selected from currency, digital currency, non-fungible tokens (NFTs), legal instruments (e.g. title to any tangible or intangible asset such as real estate, motor vehicles such as cars or boats), stocks, bonds, intellectual property (e.g. patents, trade secrets), art, tickets, coupons, tokens (such as casino tokens), notes, banking accounts, digital currency wallets, contracts, promissory notes, private keys, public keys, or any item with documentable value. This encompasses both assets that are self-validating (have an accepted value) and those that are not self-validating (e.g., wherein the asset comprises title). In the case of the latter, the asset can have some documented evidence for verification of a user and/or the asset.

In some embodiments of the invention, an asset can include “cash”, meaning any item with a known and accepted or understood market price, such as, for example, currency, cryptocurrency, stocks, and the like. In some embodiments of the invention, an asset can include any item other than cash, which can include any item with price uncertainty, such as, for example, cars, real estate, products, ideas, intellectual property, trade secrets, patents, art, carbon offsets, or any other non-fungible item.

Digital assets are here understood to be identifiable units of value, data, or art recorded in an immutable digital ledger. An immutable digital ledger is here understood as an operating blockchain network, or other similar decentralized networking technology, that can consistently reach consensus on current ownership and control rights of a digital asset. Use of these digital assets, often referred to as crypto-currencies, tokens, coins, and other monikers, is expected to increase in the years ahead as cash-intensive businesses look for innovative solutions to their problems.

Any tangible or intangible item deemed capable of producing economic value. Examples include currency, digital currency, non-fungible tokens (NFTs), legal instruments (e.g. title to any tangible or intangible asset such as real estate, motor vehicles such as cars or boats), stocks, bonds, intellectual property (e.g. patents, trade secrets, copyrights, trademarks), art, antiques, tickets, coupons, tokens (such as casino tokens), notes, banking accounts, digital currency wallets, contracts, promissory notes, private keys, public keys, permits, stakes or claims, grandfathered rights, trust deeds, liens, insurance policies, investment portfolios, domain ownership, collections.

In some embodiments, a physical or digital asset can include physical currency, item of intellectual property (such as, for example, one or more patents, trademarks, license(s) to one or more patents or trademarks, and the like), trade secret, notes, contracts, creative work (such as, for example, a work of art, music, written work, and the like), private key, and/or public key, and the like.

As used herein, the term “cryptographically secure” refers to the process of using an encryption algorithm/technique to encrypt data or information, by rewriting the data/information into cipher data which then must be decrypted using a specific cryptographic key. Cryptographic keys are created from random numbers which make them extremely hard to determine, which in turn keeps messages secured with these keys safe.

As used herein, the term “asset digitization” relates to the process of creating a digital equivalent of an asset, wherein the properties associated with the asset are carried over into the digital equivalent. An advantage of asset digitization is that the rights of ownership associated with the original asset are now capable of being transferred and exchanged on a digital platform. Assets can be represented by digital tokens held on a blockchain.

As used herein, the term “user interface” relates to the point of human-computer interaction/communication in a system or machine. For example, this can include a graphical user interface (e.g., computer with a keyboard and mouse), a menu-driven user interface (e.g. ATM), a command line interface (software command codes), touch user interface (touch screen), a voice/natural language user interface (Siri/Alexa/Google Assistant/Cortana), a form-based user interface (such as drop-down menus, text areas, check boxes to complete a form), and the like.

As used herein, the term “intake portal” relates to an area of a machine which receives input of an asset, whether the asset itself is deposited or information about the asset is deposited. This can include, for example, depositing money or other documents into a deposit slot, swiping a card through a card reader, placing a smart card up to contactless card reader, placing a phone up to contactless card reader (e.g., Apple Pay-payment tokenization), placing an image under an image scanner, placing a QR code under a QR scanner, placing a barcode under a barcode scanner, and the like.

As used herein, the term “documented evidence” (e.g., of an asset) relates to a record of information that can be used to provide proof of evidence. This includes, for example, physical identification, biometric data, witness evidence, multimedia evidence, bank statements, legal documents, chain of title and/or provenance, reputation score, receipts, official governmental documents, certified copies of records, purchase invoices, expert reports, appraisals, and/or any physical documentation relating to the user and/or the asset.

As used herein, the term “unique identifier” relates to an assigned distinguishable marker that is associated with a single entity in a defined closed system. This includes, for example, serial numbers, bar codes, QR codes, bokodes, BLE tags, SKUs, RFIDs, and the like.

As used herein, the term “proof of record” relates to documented acknowledgment of transference of an asset between parties. An example may include a receipt that contains a time stamp of receipt of the asset to the blockchain and the unique identifier associated with the asset. (Proof of Existence).

As used herein, the term “self-validating” (e.g. a self-validating asset) relates to having an accepted value that is clearly defined by specific parameters, such as currency whose value is determined by the ratio of aggregate supply to demand, as well as exchange rates.

As used herein, the term “hashing function” relates to a one-way (cannot be reversed) cryptographic algorithm that is capable of taking input data of any size and translating it to a smaller sized output data of a fixed length (known as a hash digest, hash value, hash code, or hash). A hash function ensures data integrity and secures against unauthorized modifications.

As used herein, the term “blockchain” relates to an open, distributed ledger that can store and save transactions between two parties in an efficient, verifiable, and permanent manner. A blockchain is a continuously growing record of information, called blocks, which are linked and secured using cryptography. Each block contains a cryptographic hash of the prior block, timestamp, and transaction information. By design, a blockchain is inherently protected from modification or tampering of the data. In use as a distributed ledger, a blockchain is typically handled by a peer-to-peer network that collectively adhere to a protocol for inter-node communication and validation of new blocks. Once recorded, the data in any given block is unable to be altered retroactively without the alteration of all subsequent blocks.

“Blocks” on a blockchain consist of digital pieces of information and usually have three parts: Information about transactions, such as date, time, and dollar amount of transaction. 2) Information about participants of the transactions, such as the identity of participants (unique “digital signatures” sort of like usernames, are used in place of actual names). 3) Distinguishing information that allows it to be told apart from every other block, such as a unique code called a “hash”.

A single block on the blockchain can typically store up to 1 MB of data. Depending on the size of the data, a single block can store a few thousand transactions. When a block stores new data, it is then added to the blockchain. Blockchain, as its name would suggest, consists of multiple blocks linked together. For a new block to be added to the blockchain, four things must happen: 1) An event that generates data, such as a transaction, must occur. 2) That data of the event or transaction must be verified by a network of computers for blockchains. These networks usually consist of thousands (but in the case of Bitcoin, nearly 5 million spread across the globe) computers. 3) That data must then be stored in a block. After the data has been verified as accurate, (i.e., transaction's amount, digital participants' digital signatures, etc.) it is stored in a block. There, the data will be linked to previous blocks of similar data. 4) That block must be assigned a hash. Once a block's data has been verified, is given a unique identifier called a hash. The current block is also given the hash of the most recent previous block added to the blockchain. Once it has received both hashes, the block is added to the blockchain.

When that new block is added to the blockchain, it is publicly available for anyone to view. Anyone is capable of viewing the contents of the blockchain, but users can also choose to connect their computer to the blockchain network. Their computer will then receive a copy of the blockchain that is automatically updated every time a new block is added.

Each computer in the blockchain network contains its own copy of the blockchain. Each locally held copy of the blockchain is identical but having multiple copies of that information across a network of computers makes the information much more difficult to tamper with. An advantage of blockchain is there isn't a singular, definitive record of events that can be manipulated. Instead, a hacker would need to manipulate every single copy of the blockchain contained in the network.

Blockchain technology is considered secure and trustworthy for several reasons. First, new blocks are always added to the “end” of the blockchain, which means they are stored linearly and chronologically.

Once a block has been added to the end of the blockchain, it is almost impossible to change the contents of the block. Each block contains its own “hash,” along with the “hash” of the previous block. Hash codes are created by a mathematical algorithm that translates digital information into a series of numbers and letters. If the digital information is edited, the hash code will change as well.

To change a single block, a hacker would have to change every single block after the originally altered bock on the blockchain. The power required to recalculate the hashes would take an immense and improbable amount of computational power. Essentially, once a block is added to the blockchain it becomes extremely difficult to edit and impossible to remove.

Blockchain is considered trustworthy because the blockchain networks have created and implemented specific tests for computers that want to add blocks. The tests, referred to as “consensus models,” requires the user to “prove” themselves prior to participating in the blockchain network. A common example is called “proof of work.”

In the “proof of work” example, computers must “prove” that they completed “work” by solving a complex computational math problem. If a computer successfully solves one of these problems, it is now eligible to add a block to the blockchain. The process of adding blocks to the blockchain, often referred to as “mining”, is not easy and has very large odds. To solve these complex math problems computers must run programs that require tremendous amounts of power and energy.

Proof of work is not immune to hackers, but it does make hacking the blockchain, pointless. A hacker who wanted to execute an attack on a blockchain, would need to solve complex computational math problems at large odds, just like everyone else. The cost to organize the attack would outweigh the benefits.

In a typical blockchain network, the blockchain is agreed upon by a network of users. When users join the network, their connected computer receives a copy of the blockchain that is updated every time a new block is added. If errors occur, the blockchain protocol discourages the existence of having multiple versions of the blockchain via a process called “consensus.” In the presence of multiple different copies of the blockchain, the consensus process will adopt the longest chain available. If there are more users on a blockchain, subsequently more blocks can be added to the end of the chain quicker. With that said, the truest blockchain of record will always be the one that most users trust. The consensus protocol is a great advantage of blockchain technology.

As used herein, the term “cryptocurrency” relates to a virtual (or digital) currency used as a medium of exchange implemented through the Internet. It is generally not tied or related to a specific government-backed printed currency such as the U.S. dollar or the Euro and is designed to allow instantaneous transactions and borderless ownership transfer. Cryptocurrency is an example of virtual currency, wherein cryptography is used to secure transactions and to control the creation of new units.

Several cryptocurrencies exist, with the most well-known being blockchain-based cryptocurrency. Most blockchain based cryptocurrency are decentralized in the sense that they have no singular governing entity or point of control.

Various cryptocoins exist. These include traditional “unstable” coins (e.g., bitcoin, Ethereum, etc.) as well as “stable” coins, such as USDT which is tethered to the US dollar), thus putting a hard asset behind a crypto asset. Certain robots and entities look to buy hard assets online, thus creating a vast digital marketplace managed by a program where humans can purchase various assets (e.g., a deed to a car or house). This can occur via decentralized liquidity pools.

Conventional cash machines, such as automatic teller machines (ATMs) are currently limited to receiving, processing, and allocating cash. As such, these machines have a number of limitations, which render them unsuitable for a variety of purposes services, including many which are expected to be necessary in the rapidly changing economies and lifestyles in the coming years.

For example, ATMs are limited to handling bills of currency, and are not capable of receiving, processing, or allocating assets other than currency. Further, such machines generally are only capable of handling a single type of currency. Conventional ATMs therefore cannot handle a variety of currencies, and they certainly cannot handle a variety of assets.

Conventional ATMs also do not create a unique identifier for each currency-related asset, cash, checks, or otherwise, processed through the system, nor do they treat assets independently. Lacking unique identifiers for each currency-related asset, cash, checks, or otherwise, such systems also do not transmit unique identifiers for each currency-related asset to a cryptographically secure system record, such as a blockchain.

The present invention was designed to address these deficiencies. As described herein, the system of the present invention is capable of receiving, processing, or allocating assets other than currency. Rather, the system can receive, process, and/or allocate any type of asset, including non-cash assets, and a variety of assets. In doing so, the system treats each asset independently and creates a unique identifier for each asset processed through the system. The system then can transmit the unique identifiers for each asset to a cryptographically secure system record, such as a blockchain.

For example, a conventional ATM transaction involves an individual, a currency-related asset, the ATM machine, and a physical proof of the transaction (generally a paper receipt). In the world of physical transactions, people want a physical receipt.

In contrast, a transaction using the system of the present invention involves an individual, an asset of some sort, the system of the present invention, and a transaction receipt, which could include one or more digital keys or tokens. In the world of cryptocurrency transactions, a key or token, rather than a physical receipt, is required. The physical assets input into the system can represent different types of assets. When dealing with cryptocurrency-type assets or non-cash assets, the keys or tokens that are output as a transaction receipt are important. The basic exchange model is that the user gives something to the system (e.g., the asset) and then gets something back (e.g., the key or token). It is expected that there can be a network of such systems, in many locations, which can be used all around the world in a similar fashion, similar to the worldwide network of ATM machines.

A point of differentiation between the system of the present invention and a conventional ATM is the acceptance of the physical asset. An ATM receives a predetermined type of selected currency-type asset, such as U.S. dollars, euros, etc. With the system of the present invention, the selections can be vastly bigger. At the time of input of the asset itself into the system of the present invention, the value doesn't necessarily matter, because at this point the user is just inputting something into the system (e.g., for safeguarding). The user is desirous to put an asset into the system, which can store it like a safe; for example, the asset can be in the form of a paper document (which can, for example, be currency or some form of documentation of a non-currency asset). The system receives the paper, which is scanned and put into the repository. The user receives a receipt that documents the receipt of the paper. This receipt can include, for example, the location of the paper in the system (e.g., records that the paper is in slot number one, two, or three and in repository box number ABC). The system then can digitize the asset.

As such, any user can approach the system (or any system on a network of such systems) and upload any physical asset deemed to be valuable. For example, a physical asset that is considered valuable, that is outside of a U.S. dollar or a euro, would be a car title. A user owns a car and has the title to the car. If the user is visiting a casino, for example, and the user requires additional money, the user can retrieve the car title from the hotel room (or elsewhere) and input the document into a system of the present invention which is located at the casino. In this case, an agent from the casino could view the title to confirm its authenticity, and then allow the user to insert the title, and give the transaction confirmation key or token to the casino if the casino is to give any money for it. In this scenario, there's an agency required, such that the agent is not there for the safekeeping of the title in the system, as the user can do that themselves, but is there for the valuation of the asset which has been put into the machine. The casino then gives the user money or casino chips in exchange for the title.

The system of the present invention therefore further allows the use of cryptocurrency technology to involve a buyer for the asset. For example, in general, the process of checking the validity and value of the item inserted into the machine can be expensive and difficult for the casino. If the casino gives the user money or chips for the car title, then the casino is essentially the buyer of the car title and is giving the user equal value or whatever value agreed upon. The buyer is physically present in that situation, and in fact, needs to be there before the user puts the title in the machine. Before the user would put the value in, there's an agreement that's happened offline. The system of the present invention allows that agreement to occur online, thereby vastly augmenting the potential number of buyers. Users do not need to be face-to-face with buyers. To accomplish this, the system uses the solidity of cryptocurrencies, which were made to handle money because they are mathematically safe. The system therefore uses mathematical algorithms to safeguard user items, no matter the item. In this way, a user can physically interact with a machine and engage with vast global networks to potentially find a buyer, or a better buyer, for the user's asset, effectively creating a digital marketplace or digital auction house. This can involve an asset valuation step, which can involve a human (for example, at an auction house, pawn shop, appraiser, etc.).

The system of the present invention can digitize the asset. For example, in the present scenario, the system has now received the car title and has placed it within the repository, and in addition to giving the user a transaction receipt, the system can use cryptographic technologies to digitize that asset. Digitization of the asset essentially creates a nonfungible token (NFT). An NFT is an item such as a piece of art, where no two are the same. Using blockchain and NFTs, there is enough complexity in the mathematics of the receipt to fully digitize and document the car title that was deposited in the system. The NFT is a complex mathematical identity that is stamped with the asset by the system, which gives the asset a unique identifier which is globally unique. This prevents the user from selling the asset twice and cheating the system. Theoretically, no one can copy the digital assets. In addition, given the nature of the blockchain record and the community or the network protocol, even if someone could make a copy, the network would be able to determine which one came first and was the genuine copy. The blockchain thereby protects the uniqueness of the receipt once it's copied on the Internet.

In this way, the NFT confirms that the digitized asset is a unique receipt for a unique asset (e.g., car title number 123) in the system, and the digitized asset is then put on a global network where everybody can copy everything. Once the unique digital asset is created, it can be put out to the marketplace to look for buyers, for example, for the car title for either the user or the casino. This is more advantageous for the casino, as it does not require an employee to act as an agent to the system. There is still the need to check the validity of the item going into the system, it cannot just be a piece of scrap paper. With the digital asset marketplace and employees who could be located anywhere, it will be much easier to manage the items coming into the digital marketplace or digital auction house. The marketplace or auction house can sell the digital asset, take their cut, and give the money to the user/seller.

Because marketplaces are vulnerable and are targeted by thieves and hackers, the system of the present invention assures that the assets are safe because they've been digitized and made into an NFT. The digital assets on the online marketplace can be presented to buyers. For example, a buyer can say, “I'll buy a car on the cheap from some guy in Vegas who needs money!” The digital asset goes through the bidding process, and once the bidding process is won, a buyer is now identified. The buyer provides a credit card or some form of payment. The buyer could even be using a similar system in the same network to buy the asset. Once the buyer has been identified, information is collected in terms of location of that buyer in order to transfer the asset. Payment is not given to the user/seller until the assets are being transferred. The specific sequence and timing of movements of money while represented here at a high level is programmable. The system of the present invention thereby leverages the advantage of cryptocurrencies that money can be programmed.

The system of the present invention needs to attract users, and there are liabilities to be mitigated that incentivize user to keep using the system. For example, there are risks involved with the transfer of the asset. Hence the movement of the money can be programmed, until after the asset is transferred. If the user is a frequent user and is highly trusted, i.e., a platinum user, then the payment can be programmed to occur right away. The system of the present invention leverages smart contract capabilities to move payment towards the seller. This is designed as a purely peer to peer solution rat present, meaning that this can all be fully automated. However, some implementations of this can involve more actors than just two people in one or more systems according to the present invention; for example, an auditor can be involved as necessary.

An auction house in general is a public place where buyers are invited to come and look, or browse as on eBay, which has a database of assets. A separate digital assets repository can be created at a physical or online auction house or marketplace location. The NFT stamp which represents the unique digital asset is the digital twin of the physical asset, such as the paper car title. When a digital stamp is stored in a local database, it's usually called a crypto wallet. It's a wallet because it contains the keys that control the asset, and it's the owner that proves the ownership of the asset. When, for example, a car title is inserted into the system, it is now stored in the system's digital wallet.

The digitized asset stored in the system can be called back, but is stored in the system until that time, such that a transaction involving a digital asset and a marketplace or auction house may never involve the asset physically going to the marketplace or auction house. It is expected that a third party, such as, for example, a third-party bank, may host the system or network of systems, and therefore would host the system storing the digitized asset.

The third party hosting the system or network of systems may monitor the digital assets repository whenever something new comes into the system, in order to verify the asset before showing it to anyone or before even valuing it. This could be fully remote, such as, for example, someone in China, managing a casino in Las Vegas. In this scenario, when a new digitized asset such as, for example, a car title, is received into the system, the individual in China can review the asset, zoom in on the data, call the DMV to verify, and various other authentication steps which could lead to an approval process.

The asset entered into the system can also be, for example, a smart contract. In the case of smart contracts, whenever a digital asset is moved into the digital asset repository, it effectively creates a smart contract. The smart contract created in this fashion can have ifs and thens and can be tended to as an asset, which itself has value; for practical purposes, it may be useful to set a minimum value for a contract entered into the system, such as, for example, $10,000. Such a smart contract can be reviewed by a high-level individual within the organization managing the system or network of systems, and the smart contract can be sent to that individual for review. An individual can go to system and look at the contract to verify its value. Using cryptocurrency and blockchain technology allows the process to be programmed to address the conditions for the flow of unique value.

Having described various aspects of the invention, it is useful to consider the basic components and how it can be used. In practical use, the system can involve multiple steps, including one or more of the steps outlined in specific scenarios described above.

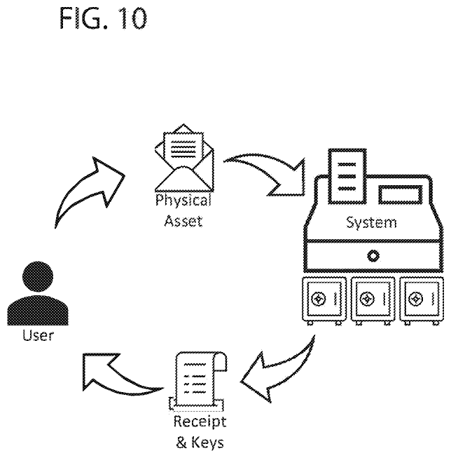

In embodiments in accordance with the present invention, the system includes the steps illustrated in FIG. 10. These include: 1) the input of an asset by a user into the system; 2) the receipt of the asset by the system; 3) the storing and digitization of the asset by the system; and 4) the provision to the user from the system of a transaction receipt containing the key to the digitized asset. As described previously, the asset can be a physical asset, can be the asset itself (such as cash), or can be some form of documentation of an asset (such as a document like a car title, if the asset is a car), or can be some form of documentation of a digital asset (such as a token, key, QR code, etc.), or the like. Once the asset is received by the system, the system stores and digitizes the asset. The system then provides a transaction receipt to the user, which has keys allowing the user to demonstrate ownership of and access the digitized asset held by the system.

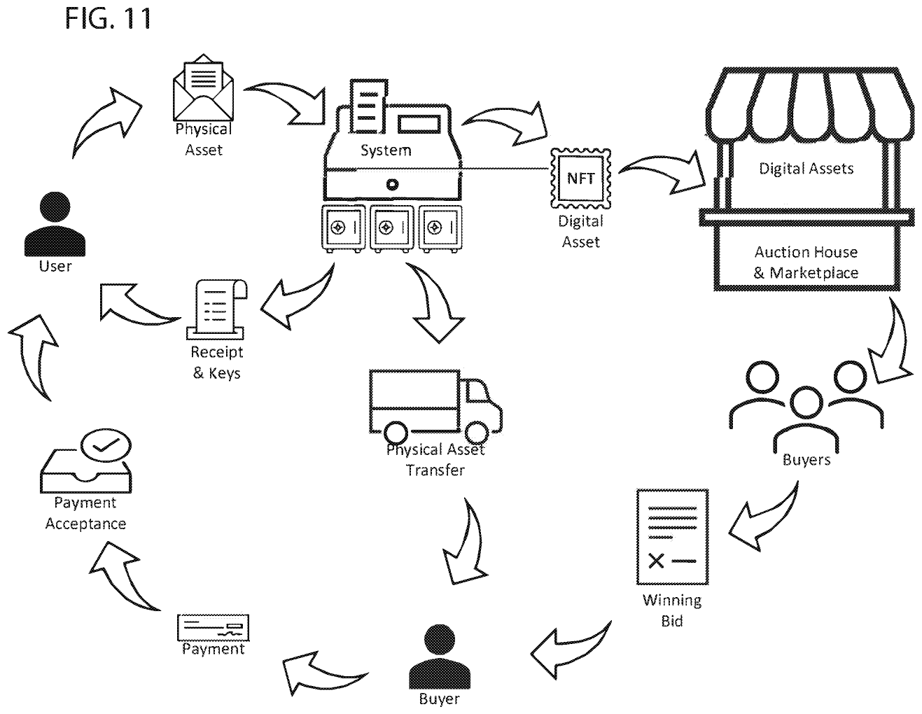

Further embodiments of methods and systems in accordance with the present invention involve additional steps where the asset is involved in a transaction with an external marketplace. One example of such a scenario is shown in FIG. 11. As described above, the user inputs an asset, or some form of documentation of an asset, into the system, which stores and digitizes the asset, and provides a transaction receipt to the user, including keys allowing the user to demonstrate ownership of and access the digitized asset held by the system. The system can record the transaction can be recorded on an immutable digital ledger (e.g., blockchain). The asset optionally can then be held internally by the system or can be physically transferred out of the system to another location, which can be onsite or offsite at another location. The digitized asset can then be communicated to a third-party marketplace or auction house for resale. Buyers can review, purchase, or bid on the digitized asset via the third-party auction house or marketplace. The purchaser or winning bidder then makes payment for and receives the asset, after which time the payment is verified and conveys to the user who originally input the asset. Upon receipt and acceptance of payment, the user has the payment, and the ownership of the asset is now with the buyer, and evidence of the new ownership can be recorded on the blockchain. For example, a user can input a car title, which is then digitized. The system can then transfer the digitized asset to an online marketplace, such as eBay, where people can purchase the car title. Once paid, the asset transfers to the buyer, and the user receives payment.

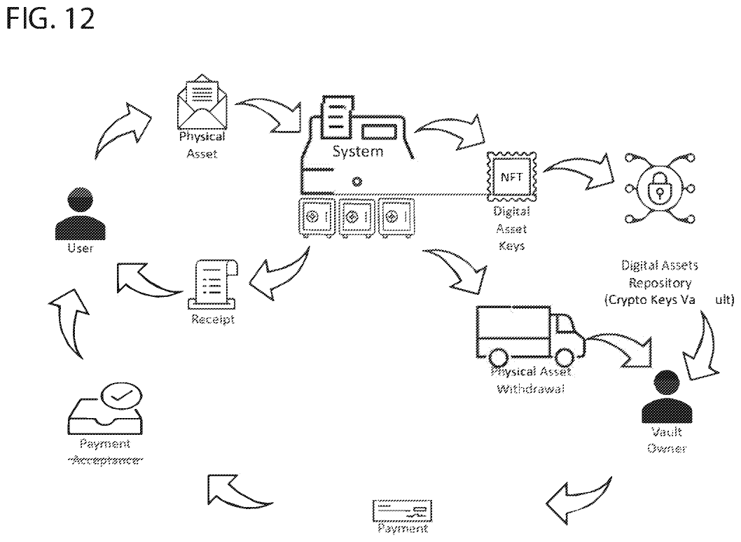

Further embodiments of methods and systems in accordance with the present invention involve additional steps where the asset is involved in a transaction with a third party. One example of such a scenario is shown in FIG. 12. As described above, the user inputs an asset, or some form of documentation of an asset, into the system, which stores and digitizes the asset, and provides a transaction receipt to the user, including keys allowing the user to demonstrate ownership of and access the digitized asset held by the system. The transaction can be recorded on an immutable digital ledger, or blockchain. The asset can then be digitized into a non-fungible token (NFT) and placed into a digital asset repository (i.e., a vault of crypto keys). The asset optionally can then be held internally by the system or can be physically transferred out of the system to the owner of the digital asset repository or crypto keys vault, which can be onsite or offsite at another location. The owner of the vault or digital asset repository then makes payment for the asset, after which time the payment is verified and conveys to the user who originally input the asset. Upon receipt and acceptance of payment, the user has the payment, and the ownership of the asset is now with the owner of the vault or digital asset repository, and evidence of the new ownership can be recorded on the blockchain.

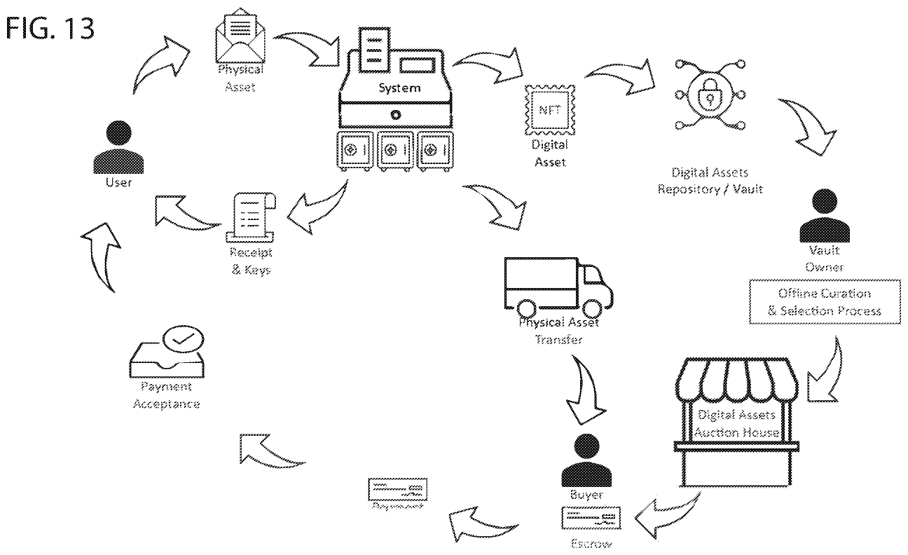

Further embodiments of methods and systems in accordance with the present invention involve additional steps where the asset is involved in a transaction with a third party who then involves an external marketplace. One example of such a scenario is shown in FIG. 13. As described above, the user inputs an asset, or some form of documentation of an asset, into the system, which stores and digitizes the asset, and provides a transaction receipt to the user, including keys allowing the user to demonstrate ownership of and access the digitized asset held by the system. The transaction can be recorded on an immutable digital ledger, or blockchain. The asset can then be digitized into an NFT and placed into a digital asset repository (i.e., a vault of crypto keys). The asset optionally can then be held internally by the system or can be physically transferred out of the system to another location, which can be onsite or offsite at another location. The owner of the digital asset repository or crypto keys vault then reviews the asset and conducts offline curation and selection, which can include valuation, pricing, authentication, and various steps to establish the provenance and/or pricing and/or marketing strategy for the asset. The owner of the digital asset repository or crypto keys vault then can communicate the digitized asset to a third-party marketplace or auction house for resale. Buyers can review, purchase, or bid on the digitized asset via the third-party auction house or marketplace. The purchaser or winning bidder then makes payment for and receives the asset, after which time the payment is verified and conveys to the user who originally input the asset. Upon receipt and acceptance of payment, user has the payment, and the ownership of the asset is now with the buyer, and evidence of the new ownership can be recorded on the blockchain.

When considering the type of asset, any of the asset types described herein can be used in accordance with the present invention. In addition to cash and checks, which may be well understood, the invention encompasses use of any type of asset that can be documented or demonstrated in some way. This includes cash, checks, non-fungible tokens (NFTs), legal instruments (e.g. title to any tangible or intangible asset such as real estate, motor vehicles such as cars or boats), stocks, bonds, intellectual property (e.g. patents, trade secrets), art, tickets, coupons, tokens (such as casino tokens), notes, banking accounts, digital currency wallets, contracts, promissory notes, private keys, public keys, or any item with documentable value. For example, cars and real estate can be demonstrated to the system via car title, house title, etc. Smart contracts or other contracts or agreements can be demonstrated to the system by providing physical evidence or documentation of the contract. Art can be demonstrated to the system by providing a photograph and any provenance documentation. Assets such as coupons or tickets can be demonstrated by inserting the actual item or a representation of the item in case it is not desirous to have the system hold the item itself. Digital assets, such as NFTs and crypto wallets, can be demonstrated to the system by providing the key. In some cases, documentation of the asset can include the user providing physical identification, biometric data, witness evidence, multimedia evidence, bank statements, legal documents, chain of title and/or provenance, reputation score, and/or any physical documentation relating to the user and/or the asset.

The system can involve optional authentication, verification, validation, and/or valuation steps, which can be added to the digital ledger for the asset. The optional authentication, verification, validation, and/or valuation steps can be executed by a human or network of humans, or this process can be fully automated. These steps can occur within or outside of the system.

The main concept of the system is to treat all pieces of asset as unique items of inventory carrying valuable data. The error and problem of prior cash-handling systems is the treatment of cash as fungible. This creates opportunities for fraud, mistake, and theft. But for each asset with a unique identity due to having a unique identifier, scanning technology makes it completely unnecessary to treat all asset items as fungible. Treating each asset as a discrete inventory item also significantly reduces the ability to counterfeit or duplicate known asset items within the system. All asset in a transaction can be treated as unique items of inventory carrying valuable unique data. An early step in any transaction according to embodiments of the invention is to capture the data from each asset item into a data stream. That data stream can further optionally be rendered secure and hackproof via blockchain or other secure technology. The system is concerned that each item is a unique individual with a unique identity and therefore each item's location in the system can also be tracked, whether the item is in a primary repository, a bundle within a secondary repository, or a brick; likewise the location of each bundle and each brick can also be tracked. In some embodiments a brick can be assembled to contain “loose” cash—i.e., cash that has not previously been packaged into DSPs. In such embodiments the inventory of the brick can be an inventory of each asset item but does not include any DSPs and hence does not include any DSPIDs or other information relating to DSPs such as a DSP sub-inventory.

The invention can be embodied in different forms. For example, the invention can relate to a traditional cash register with two slots: an intake scanning slot & an output scanning slot, where a cashier can operate the cash register by interacting with its user interface, such as by pressing keys. As another example, the invention can be configured in a way that is similar to an ATM, having a touch screen operated by the user without requiring a cashier, where the user can interact with touch screen and can input and retrieve money directly through a single point of interaction capable of scanning asset items in and out of the system, or via an input portal/scanner and an output portal/scanner. The user interface can be configured to achieve additional functionality, such as display of products to be sold, quantities and prices of said products, displaying user or customer account information, allow modification of the transaction or transactions, and more. The user interface can be configured to accept input and provide information verbally, through the use of keys, through use of a touchscreen, and more. In some embodiments, additional user interfaces can be provided for “back of house” settings, which allow review of information in the system record, such as total value, inventory of asset items, activity data, and more without being directly tied to an intake or output portal.

The system can include two-factor authentication. The system can include bio-authentication. For example, some embodiments can include user verification capabilities in the user interface such as thumbprint and/or retina verification and/or facial recognition and/or voice recognition, and/or the like.

The cash repositories of the system can be designed to have desired characteristics. These characteristics include, but are not limited to: secure (in that the repository cannot be carried away), tamper-proof (in that the repository cannot be opened without authentication), fireproof (in that the repository is resistant to or impervious to fire), waterproof (in that the repository is resistant to or impervious to penetration by water), blast proof (in that the repository is resistant to or impervious to alteration or breach by explosives or ballistics), and EMP-proof (in that the system is resistant to or impervious to any effects of a electromagnetic pulse otherwise capable of damaging or de-activating electronic devices). In some embodiments, cash is stored in an airtight container. In some embodiments, a set amount of bills can be vacuum sealed for efficiency and safekeeping.

The data manager and records within the system can also be designed to have desired characteristics, such as EMP-proof (in that the data will not be destroyed upon exposure to an electromagnetic pulse), offsite backup (in that the data is stored either on a cloud platform or remote servers), and blockchain interface (in that the data manager can interact with blockchain protocols to enhance security).

### Four Stage System Embodiment

The following is an embodiment of the system that includes 4 stages. The system can also comprise any 1, 2, 3, or 4 of these stages.

### Stage 1—Countertop Cashier-Facing Device Like a Cash Register or Customer-Facing Device Like an ATM

An intake portal is provided which is capable of accepting cash. The user inserts cash into the intake portal. The cash is passed from said intake portal to a scanner capable of capturing information from the asset items. The scanner scans each inserted asset item for value and unique identifiers. The scanner can also scan the asset items to verify their authenticity. After scanning, the asset items pass to a primary repository, such as a drawer. In particular embodiments, a plurality of primary repositories is available to accept cash after it has passed through the scanner. Within each of the plurality of primary repositories is a plurality of currency store areas, and at least one device capable of sorting the asset items based on one or more characteristics of that item. For example, the device can be capable of sorting the asset items based on value denomination or national issuer. The items are sorted for storage within the primary repository, with each of the plurality of stores within the primary repository corresponding to a particular characteristic or set of characteristics of the items. In some embodiments, the items with like value denominations are stored together. In other embodiments, items of like national issuer are stored together. In particular embodiments, the primary repositories possess desired security features such as physical indestructability and multi-factor authentication for opening. In some embodiments, the transaction cannot be completed until cash is inserted which meets at least the transaction price, reducing opportunities for theft, fraud, or error.

The information captured by the scanner for each asset item is passed to a data processor which creates a record for each item scanned. The record can comprise the item's value denomination, unique identifier, and more. An inventory is kept within the data manager of the total cash value and all individual uniquely identified asset items contained within the system. Records are passed from the scanner through the data processor to the data manager for inclusion in the system inventory. Additional transaction information (such as product sold and consumer identity) can be captured and retained by the data manager as desired. In some embodiments, the system inventory is maintained in real time. In some embodiments, the scanner and data manager further compare the identity of each item against a database of known items to verify that the item is authentic, rendering payment with counterfeit items nearly or entirely impossible.

The device further possesses the ability to dispense cash from within the system. Cash can be dispensed in the form of making change at the end of a transaction, where the data manager calculates the amount of change to be dispensed. Cash can be dispensed upon request from the user, for example in an ATM-like embodiment where the user, through the user interface, enters a desired amount of cash to be dispensed, and such amount is transferred to the data manager. Each of the plurality of primary repositories is equipped with at least one device capable of retrieving asset items as required for dispensing. When dispensing is required, said retrieving device retrieves asset items in the amount specified by the data manager (“output asset”). The retrieved items are passed through a scanner capable of capturing item data from the asset items. In some embodiments, this scanner is the same scanner through which items are passed from the intake portal. In some embodiments, this scanner is distinct from the scanner connected to the intake portal. The item data of the output asset is recorded by the scanner, and the records in the data manager are updated to reflect the value of cash dispensed and the identities of the asset items which have left the system. The output asset is provided to an output portal, where it becomes accessible to a person using the system. In some embodiments, the output portal is a device which also serves as the intake portal. In some embodiments, the output portal is distinct from the intake portal.

### Stage 2—Dynamic Packaging and Storage of Accumulated Cash

The plurality of primary repositories retain enough cash to fulfill routine transactional needs dependent on industry and business type. Cash in excess of these needs proceeds to the second stage of the system: dynamic storage. Collections of items are sorted and grouped into dynamic storage packets (“bundles”). A bundle contains a predetermined total cash value and can be made up of any number of items of the same or differing value denominations. Bundles can be made up of asset items possessing distinct or similar characteristics in their type or item data. Bundles can accomplish the physical grouping of the items in a variety of ways. For example, in a bundle of bills, the bills can be wrapped with a currency strap. For example, a bundle of bills can be vacuum sealed in plastic. For example, in a bundle of coins or coin-like items, the items can be placed in a sleeve which is then closed at both ends, similar to a traditional coin roll. For example, asset items can be placed in sealable container which can then be moved between stages.

Bundles are formed during a dynamic packaging interstage. This process (“bundling”) can be set to occur at predetermined times, such as shift changes or close of business, or at predetermined amounts of total cash or number of asset items of a given denomination. For example, bundling can be set to occur whenever 50 bills of like denomination are present in the primary repository. Alternatively, a bundling event may be triggered when a predetermined threshold is reached, such that a portion of the existing bills are bundled for dynamic storage and a reserve cache of other un-bundled bills remain in the primary repository for further transactions. Within the primary repository, a device or devices capable of retrieving asset items is provided. The retrieving device or devices retrieves items with a total value equal to the value of the bundle to be created. The retrieved items are provided to a scanner capable of capturing item data from each item. Following such scanning, the retrieved items are then passed to a device configured to physically group the items into a bundle.

Each bundle is assigned a dynamic storage packet identifier (DSPID) upon creation. This identifier is comprised of a unique digital signature assigned by the data manager. A list of each DSPID is maintained in a dedicated inventory of DSPIDs, where said inventory is a sub-inventory contained in the system inventory. The DSPID is recorded with a value in said sub-inventory. In some embodiments, the value of a bundle is encoded in the DSPID. During bundle creation, a record is made of each asset item, such as value denomination, identifier, national issuer, and other item data, that is included in the bundle. Each DSPID is linked to the record of items within the bundle bearing the respective DSPID. Through this, a user can identify each and every asset item in any given bundle through that bundle's DSPID. The DSPID is physically attached to the bundle, for example by a barcode or QR code stamped on the binding of the bundle or an RFID chip included in the bundle, or the like. The DSPID remains associated with and travels with the bundle until the cash is unbundled.

Once formed, bundles are transferred to a separate secondary repository. In some embodiments, the secondary repository is located directly underneath the cash drawer. In other embodiments, the secondary repository is located elsewhere in the business facility, such as in a basement or a vault. In some embodiments, the transfer of bundles is achieved through automated mechanical means. For example, in an embodiment where the secondary repository is located directly underneath the primary repository, the device which physically groups the items can be further configured to pass the formed bundle through a slot between the primary and secondary repository. For example, in embodiments where the secondary repository is remote from the primary repository, bundles can be conveyed to it by a network of vacuum tubes, conveyors, and/or the like. In some embodiments, the transfer of bundles involves human input. For example, formed bundles can be located in a distinct storage area within the primary repository, and upon a human user pressing a button on the user interface, the formed bundles are dropped from the primary repository to the secondary repository through a trapdoor-like opening connecting the two repositories. In some embodiments, a human can physically move the bundles from the primary repository to the secondary repository. The secondary repository can be provided with significant security features consistent with best practices. Cash is retained in the secondary repository until it can be moved to a bank or utilized for the payment of business expenses, such as rent, cost of goods, or payroll.

### Stage 2A—Bank Deposit (Terminal Stage for Users Wishing to Deposit in a Bank)

When the terminal goal of the system is depositing the asset items in a bank, the transfer of bundles from the primary repository to the secondary repository is, in most embodiments, irreversible. The DSPID can optionally be transmitted to the user's bank when the bundle is created. By transferring the DSPID, the bank recognizes that the user possesses an amount equivalent to the bundle(s).

Flow of cash from Stage 1 to Stage 2A is unidirectional. In some embodiments, at the end of a cash cycle, such as the close of business, a shift change, or any other pre-set period, some or all of the cash in the primary repository can be bundled and transferred to the secondary repository even if no other predetermined bundling threshold has been reached. Bundles created in this way are assigned a DSPID, and that DSPID is linked to the record of item data for the items contained in the bundle, just as in regular bundle creation. Bundles created in this way are additionally recorded as having a distinct value, equal to the value of the asset items contained within the bundle. The DSPID, irregular value, and record of item data are stored in the DSPID sub-inventory just as in regular bundle creation.

The system is configured to allow removal of bundles from the secondary repository, such as when a code is entered or at the end of each business period such as, for example, a day or a week. The bundles with DSPIDs are physically removed from the secondary repository and delivered to the user's bank, where verification of amounts and value is greatly facilitated by correlation of the DSPIDs already in the bank's possession and/or delivered with the bundles. Because the DSPID is associated with discrete asset items, there is no need to remove items for bank deposit on an item-by-item basis. In some cases, the bank can unbundle the cash for its own purposes, and the information on the destroyed bundles can be expunged from the system. In other cases, the bank can retain the cash in the bundled state, incorporate the bundle's associated information into its own systems, and/or facilitate further transactions using the bundle(s). In some embodiments, the system inventory creates and retains a record of all bundles and asset items which have been deposited into a bank.

Some embodiments of the invention provide a cash inventory and tracking system, without regard to the mechanical features by which the inventory is created and/or security provided. In these embodiments, cash is scanned for creation of the inventory, whether in a system as described herein or in any other system capable of scanning and capturing the relevant data for a cash inventory system. In some embodiments, cash having been thus inventoried is bundled and a DSPID is created for the bundle, to facilitate tracking of a group of bills in the system. The system can include data for movement of bundles within the system, such as movement within a bank, a private vault system, or the like. In some embodiments, bundles and/or loose inventoried bills are packaged into bricks to secure larger value amounts for ease of tracking and transport without risk of loss, theft, fraud, or damage by fire, water, or the like.

Some embodiments of the invention provide a cash-based banking system wherein transactions are collateralized by cash inventoried according to the cash inventory and tracking system of the invention. The banking system can further include one or more locations for centralized storage of cash collateral in the form of bricks and/or bundles and/or loose, inventoried, bills. The banking system can be adapted to permit electronic transactions in which parties trade title to the bricks and/or bundles and/or individual bills by trading electronic information permitting control over and access to the bricks and/or bundles and/or individual bills. The difference between this banking system and conventional banking systems is that the transactions are collateralized by specific, unique items of cash in inventory rather than by cash equivalents or claims on deliverable but fungible value units. In the system, each and every brick, bundle and/or loose bill is a unique item of property personal to one party in the transaction and title to those specific items of property is transferred by transfer of electronic information permitting real-time transactions between parties anywhere in the world. In this system, a party receiving payment by obtaining title to specific bricks, bundles, etc., can then claim physical possession and delivery of these items or can maintain a ledger of such items of property for other transactions.

Transactions and related data can be handled, tracked, and secured by approaches known in the art and can be rendered hackproof via use of blockchain technology, encryption, or the like.

### Stage 2B—Passthrough (Non-Terminal Stage for Users Wishing to Keep Cash on Hand)

When cash is to be retained, either because this is desired or because the system's user cannot access traditional banking services, the transfer of bundles from the primary repository to the secondary repository is reversible.

Flow of cash from Stage 1 to Stage 2B is bidirectional. Functionally, Stage 2B is the user's local bank or is equivalent to the user's checking account. When a vendor delivers goods or presents an invoice for services, and/or when the user must pay one or more employees, and/or when the user must make a tax payment, or the like, it becomes necessary for the user to retrieve an amount of cash that is greater than would be available in Stage 1 for register-level transactions.

The user in need of retrieving cash from the secondary repository can interact with the user interface and indicate the amount desired to be extracted from the secondary repository. In some embodiments, the secondary repository is equipped with a device or devices which can identify one or more bundles, wherein said bundles contain at least as much value as the total value to be distributed. Said devices are further configured to provide the bundles to a scanner, which scans the DSPID. In further embodiments, said device or devices then provide the bundle or bundles to the user through a bundle output portal. In further embodiments, said devices are capable of providing the bundles to one or more devices which physically separate the asset items, thereby depackaging the bundle. The asset items are then provided to the user through the output portal. In other embodiments, the user is granted access to the secondary repository and physically removes a bundle or bundles which contain at least as much value as the total value to be distributed. The user can scan the DSPID of each bundle removed.

When a DSPID is scanned during the removal, the data manager can update the records of bundles on hand to remove the bundles associated with the scanned DSPID(s) from the bundle sub-inventory. The data manager can also remove from the system inventory the records of the asset items contained in each bundle which is scanned out. From the system's perspective, the bundle has been destroyed, and all the items contained within the bundle are no longer present in the system. The removal of the bundles and items can be reflected in the total cash value and record of asset items in the system inventory. In some embodiments, these values are updated in real time upon the scanning out of a bundle. The user can hand over physical cash as required for the transaction. Cash remaining in the user's possession after the transaction is completed can be returned to the system through Stage 1. In some embodiments, the system can be configured to allow bundles to be scanned into the system as bundles rather than individual asset items, where the system inventory and bundle sub-inventory are updated accordingly. In some embodiments, the system inventory creates and maintains a payout ledger containing an ongoing record of all bundles and asset items which have been outputted from the system. In some embodiments, the payout ledger can retain additional information, such as the reason for the output or to whom the outputted asset was provided. In some embodiments, this payout ledger can interface with other systems or other instances of the present invention to assist in verifying transactions.

### Stage 3—Static Packaging and Long-Term Storage

In Stage 3, a plurality of bundles are physically packaged together into a static storage package for long-term retention of large quantities of cash. Said static storage packages (“bricks”) can comprise any container or method of physically retaining the bundles. The bricks can be configured to have desired security characteristics, such as being fireproof, tamperproof, waterproof, EMP-proof, physically indestructible, and/or the like. Each brick has a preset value such as, for example, $25 k, $50 k, $100 k, $250 k, $500 k, $1M. In some embodiments, the system can aggregate bricks of smaller value into bricks of larger value. For example, ten bricks, each with a value of $100,000, can be aggregated into a brick with a value of $1 million.

The formation of bricks can be achieved in a variety of ways. The principal steps comprise selecting at least two bundles with a value equal to the value of the brick to be created, retrieving said two or more bundles from the secondary repository, scanning the DSPIDs of each of the two or more bundles, and physically packaging the two or more bundles into the brick. In some embodiments, the secondary repository is provided with one or more devices configured to carry out the steps of brick formation. In some embodiments, a separate device or set of devices is provided which is capable of carrying out the steps of brick formation, and the bundles are provided from the secondary repository to the separate device, where the provision is facilitated by a device, devices, or by human means.

Upon creation, bricks (Static Storage Packages) are assigned a unique identifier, a Static Storage Package Identifier or SSPID. This identifier is comprised of a unique digital signature assigned by the data manager. A list of each SSPID is maintained in a dedicated inventory of SSPIDs, where said inventory is a sub-inventory contained in the system inventory. The SSPID is recorded with a value in said sub-inventory. In some embodiments, the value of a brick is encoded in the SSPID. During brick creation, a record is made of each bundle that is included in the brick. This record further contains a record of each asset item, such as value denomination, identifier, national issuer, and other item data, that is included in each of the bundles. Each SSPID is linked to the record of bundles and items within the brick bearing the respective SSPID. Through this, a user can identify each and every bundle and asset item in any given brick through that brick's SSPID. The SSPID is physically attached to the brick, for example by a barcode or QR code stamped on the exterior of the brick or an RFID chip included in the brick structure, or the like. The SSPID remains associated with and travels with the brick until the brick is accessed. In embodiments where bricks are aggregated, a similar process is followed, where a record is made of every brick, bundle, and item which is contained within the aggregated brick. In some embodiments, the SSPID is encrypted. In some embodiments, the SSPID can include or be linked to records of additional information, such as the physical location of the brick. Through the SSPID, an amount of physical cash is effectively converted to a single identifier, enabling easy transfer.

Bricks are secured against physical opening once formed. Bricks can be secured such that they can only be opened with a unique code, by a physical key, by an electronic signal transmission, and/or the like (any of such means a “key”). Without the key, a person cannot access the cash within the brick. Therefore, the individual possessing the SSPID and key associated with a particular brick possesses effective title of the cash contained in that brick. In some embodiments, using the key and accessing the brick creates an event that is saved to the data manager and destroys the integrity of the brick. In some embodiments a brick can only be opened in a designated facility or using designated hardware. In such embodiments, for example, a brick is engaged with the opening hardware and an unlock code is transmitted to the hardware or is physically entered into the hardware. Upon entry of a correct unlock code, the hardware reverses or deactivates the locking mechanism making the brick impenetrable and the brick is thus opened. In some embodiments, the physical act of opening the brick causes a communication with the inventory system to record that the brick no longer exists as such and that the items within the brick are removed from the inventory. The SSPID record is updated to reflect that the associated brick has been accessed and is no longer recognized as a brick within the system. The records of DSPIDs and asset items that were contained within the brick are updated to reflect that the bundles and items contained in the brick have left the system. Once the brick is opened, it becomes a box of cash with no “brick nature” ever again. In this way, a brick is analogous to an egg: it can only be opened once and can never be recreated or returned to its original state. Once a brick is opened, cash must be returned to the system as asset items, bundles, or smaller bricks, by scanning such items, bundles, or bricks back into the system, which can cause said items, bundles, or bricks to be assigned new identifiers within the system inventory.

The physical bricks can be stored in any location desired by the user. The location of the bricks can be provided with additional security measures to safeguard the bricks. In some embodiments, the bricks are stored in a container meeting standard shipping dimensions to facilitate easier transportation of the physical cash. In some embodiments, the bricks can be moved by an armored car integrated with the cash-management system capable of tracking the brick SSPIDs and locations. In some embodiments, the bricks can be stored at a warehouse designed with security features to be a safe repository for bricks. Said warehouse can be owned or operated by the party owning the bricks within, or by a third party. Thus, a user can maintain on or more collections of bricks as a private vault or vaults without incurring banking fees.

Within and across instances of the cash-management system, bricks are standardized and secure such that they can function as reliable collateral for transactions. A brick can be removed from one instance of the system by scanning its SSPID out of that instance, and then scanned into another instance of the system by scanning the SSPID into that instance. The two instances communicate from their respective inventories the records of bundles, items, and item data, and other records associated with the brick, such that the records indicate that said bundles and items are present in the second instances and not present in the first instance. In some embodiments, this transfer of information is recorded and verified by blockchain, encryption, and/or the like. The standardized nature of the bricks enables the user to transfer bricks as described in Stage 4 to facilitate transactions.

Stage 4—Transactions with Bricks as Collateral

Once an individual has accumulated bricks and stored them in a secure location, they can then use the bricks as collateral for transactions. This can be accomplished by transmitting the SSPID and brick key to another party, thereby transferring title to the underlying cash. In addition to the transfer of the SSPID, the records of the bundles, items, and item data contained within the brick is transferred to the transferee's system inventory. The transfer of records of the contents of each brick allows for certainty of the brick's contents between parties. Further, because the brick can be equipped with physical, electronic, and other security features, parties can view bricks as secure collateral for a transaction. Transfers of the SSPID and brick key do not require the transfer of the physical cash, which becomes necessary only when the transferee wishes to extract physical cash. Because the SSPID and brick key can both be electronic records, the transfer is as simple as any other form of electronic fund transfer or transaction. The transferee can continue to hold title to the brick for use as collateral in future transactions.

The transfer of the SSPID and key avoids several problems traditionally associated with large cash transactions. First, it makes physical moving of the cash unnecessary, because cash need not be moved or removed from the bricks until the receiving party wishes to actually use the items contained in the brick. This eliminates risks of cash being lost during the physical relocation process by theft or error. In essence, the bricks function as a vault, and only the right to access the vault is transferred. Further, because each brick is associated with an inventory of cash value and item identity, there is no need to count large amounts of physical cash. In some embodiments, in which the system is configured to verify the authenticity of each item as it enters the system, the transferee is further assured that the items in the brick are not counterfeits.

Once the SSPID and brick key are transferred, the transferee is the owner of the brick. The transferee can then use the key as needed to open the brick and retrieve the physical cash. As noted above, this destroys the integrity of the brick in the data manager. Thus, while redemption of the physical cash is capable of being done at any time, excess physical cash must be returned to the cash management system and optionally placed into new bundles or bricks. The transferee is then free to take the needed cash and recreate bundles or bricks out of the remaining cash. The data manager can be configured to track the location and identity of all bricks and can track ownership of each brick as well. In some embodiments, a centralized record of title and transactions across all instances of the system is maintained and provides confidence in transfers. Thus, businesses locked out of the traditional banking system to quickly and easily transfer large amounts of money.

### Further Embodiments

In an example involving a store employee and a customer, the store employee can advise a customer on a selection. The customer can select the product desired, scan the barcode of said product through the user interface, and the user interface displays the final transaction price on a screen. The customer then inserts cash and/or one or more assets of roughly equivalent value into the intake portal, and once an amount equal to or greater than the transaction price is inserted, the user interface asks if this is really the final sale. The customer can then receive a transaction receipt for input of the asset(s) containing a key holding access to the value of the assets within the system.

In some embodiments, the system allows for the job of the store employee to advise a customer on product(s) and/or packaging up the product(s) without handling cash. In some embodiments, the system includes integrated methods to manage product inventory, track consumer purchase behavior, correlate inventory and pricing, or other retail functions. In other embodiments, the system is designed to interface with third-party retail software capable of carrying out common retail operations. In further embodiments, the system is capable of fulfilling reporting and compliance requirements for the business. For example, the system can be capable of meeting tracking and reporting requirements imposed by the government on the cannabis industry. In some embodiments, the system is capable of creating and printing RFID tags to be attached to products. In further embodiments, the system is capable of interfacing with compliance software.

In some embodiments, the system can handle spontaneous cash needs. For example, vendors can come in without notice. The business at that point needs enough cash to complete the purchase from the vendor on the spot. In some embodiments, the system is capable of removing cash from a secondary local repository, unbundling the cash, and recording the cash value and identity of items removed from the system by the transaction. In further embodiments, the system can accept a vendor form enabling it to record and process routine or one-time transactions.

In some embodiments, the system possesses additional sorting functions, such as designating particular asset items for changemaking, designating a particular set of items, or one or more bundles, for bank deposit or brick formation, and others. These sorting functions can further be enabled by a system containing multiple local or remote cash repositories.

In some embodiments, the system comprises a standalone countertop unit. In some embodiments, the countertop unit is directly connected to a safe below it. In further embodiments, cash is bundled and dropped from the countertop unit into the safe when a certain number of a denomination of currency is reached. For example, when 100 $20 bills are in the countertop unit, 50 are bundled and dropped into the safe. In other embodiments, cash is bundled and dropped at predetermined times, such as close of business or shift changes.

In some embodiments, the bundles or bricks are packaged in any available material, e.g., anything from shrink wrap to concrete. In some embodiments, additional security features are provided for bundles or bricks, such as two factor authentication, encryption, physical barriers, electronic barriers, and others.

In some embodiments, the cash-management system and data manager are capable of carrying out additional software functions, such as: point of sale programs, inventory management, pricing, government compliance, corporate compliance, RFID product tracking, vendor and source tracking, consumer identity, product sales volume analysis, tax calculation and remittance, real time cash on hand balancing, transaction reporting, and integration functionality with third-party software.

In some embodiments, the system is designed to possess additional technical support features, such as:
Limited need for manual backup
Supervised vending
Multiple drawers with distinct data sets, where drawers can be swapped on demand
Rendering a malfunctioning drawer inaccessible until full functionality is returned
Inaccessible repositories for additional security
Consumer and employee/user identification
Regulatory compliance features
Interoperability with all similar systems world-wide
Inter-merchant information sharing

In some embodiments, the system comprises further additional features for a desired industry. In some embodiments, the system is connected to a casino chip dispenser to facilitate the trade of cash for chips. In some embodiments, the system is employed to create customized brick amounts for banks as an alternative means of electronic fund transfer. In some embodiments, the system is utilized by businesses to purchase product and retain payment in a secure manner. In some embodiments, the system is employed in tipping industries (such as fast food, dining, or strip clubs) to sort cash into individual employee accounts to eliminate the need to count and split tips. In some embodiments, the system is employed to accept cash in exchange for a QR code or other digital identifier which the user carries in place of a ticket for events.

In some embodiments, the system can incorporate quasi-monetary items, for example casino chips. In some embodiments, the system can incorporate fungible asset items, wherein each item does not have a unique identifier. In some further embodiments, fungible asset is stored in a separate repository. In some further embodiments, information on fungible items within the system is recorded in the data manager, for example, a record of the type of fungible item, the value of each and all fungible items, and the count of each type of and the total fungible items within the system. In some embodiments, the fungible and non-fungible items are stored in the same repositories. An example of a fungible item of cash is a coin from most countries that issue coins. Lacking any unique identifiers, coins cannot be treated as unique items of inventory. However, bundles of coins can be labeled, given a DSPID, and subsequently tracked. In some embodiments, the system can incorporate cryptocurrency, either in digital or electronic format or through the use of physical items corresponding to set amounts of cryptocurrency and/or specific cryptocurrency wallets.

### EXAMPLES

### Example 1

This example follows the daily activity in a cannabis dispensary which utilizes the cash management system of the present invention.

At the beginning of the business day, the system inventory contains the following data:

TABLE 1
ITEMS IN PRIMARY REPOSITORY

| Item Type | Item Value | Item Identifiers | | | |
|---|---|---|---|---|---|
| United States Bill | $1 | E1234567K | E1234568K | E1234569K | E1234570K |
| | | E1234571K | E1234572K | E1234574K | E1234575K |
| | | E1234576K | | | |
| United States Bill | $5 | E1234577K | E1234578K | | |
| United States Bill | $10 | E1234579K | E1234580K | E1234581K | |
| United States Bill | $20 | E1234582K | E1234583K | E1234584K | E1234585K |
| | | E1234586K | | | |
| United States Bill | $50 | E1234587K | E1234588K | | |
| United States Bill | $100 | E1234589K | E1234590K | E1234591K | E1234592K |
| | | E1234593K | E1234594K | E1234595K | E1234596K |
| | | E1234597K | | | |

TABLE 2
FUNGIBLE ASSET

| Item Type | Item Value | Item Count |
|---|---|---|
| United States Quarter | $0.25 | 12 |
| United States Dime | $0.10 | 22 |
| United States Nickel | $0.05 | 8 |
| United States Penny | $0.01 | 64 |
| Total on Hand | $6.24 | 106 |

TABLE 3
BUNDLES

| | | Bundle Contents | | | | |
|---|---|---|---|---|---|---|
| | | Item | Item | | | |
| DSPID | Value | Type | Value | Item Identifiers | | |
| AA123 | $100 | United | $20 | E9876543M | E9876542M | E9876541M |
| | | States | | E9876539M | E9876538M | |
| | | Bill | | | | |
| AB567 | $20 | United | $1 | E4563219K | E4563218K | E4563217K |
| | | States | | E4563216K | E4563215K | E4563214K |
| | | Bill | | E4563213K | E4563212K | E4563211K |
| | | | | E4563210K | E4563209K | E4563208K |
| | | | | E4563207K | E4563206K | E4563205K |
| | | | | E4563204K | E4563203K | E4563202K |
| | | | | E4563201K | E4563200K | |

TABLE 4
BRICKS

| | | Brick Contents | | | | | |
|---|---|---|---|---|---|---|---|
| | | | | Bundle Contents | | | |
| | | | | Item | Item | | |
| SSPID | Value | DSPID | Value | Type | Value | Item Identifiers | |
| B987Z | $500 | XY234 | $100 | United | $20 | C2468135M | C2468136M |
| | | | | States | | C2468137M | C2468138M |
| | | | | Bill | | C2468139M | |
| | | AK470 | $100 | United | $20 | C2468140M | C2468141M |
| | | | | States | | C2468142M | C2468143M |
| | | | | Bill | | C2468144M | |
| | | DU093 | $100 | United | $20 | C2468145M | C2468146M |
| | | | | States | | C2468147M | C2468148M |
| | | | | Bill | | C2468149M | |
| | | GJ213 | $100 | United | $20 | C2468150M | C2468151M |
| | | | | States | | C2468152M | C2468153M |
| | | | | Bill | | C2468154M | |
| | | TR346 | $100 | United | $20 | C2468155M | C2468156M |
| | | | | States | | C2468157M | C2468158M |
| | | | | Bill | | C2468159M | |

*Note-
this example of a brick having a total value of $500 is provided for convenience. In most embodiments a brick is intended to aggregate large amounts of money-amounts that would be worth securing in the physical structure of the brick and that may be inconvenient to count.

TABLE 5
TRANSACTION HISTORY

Transaction 141
. . .
Transaction 142

A customer enters the dispensary. The customer consults with a budtender who is employed by the dispensary. The budtender recommends several products, and the customer decides to purchase some of those products. The budtender enters the products and quantities into the user interface, which comprises a touchscreen displaying a menu of products, sitting on top of a counter. The touchscreen then displays a list of the products to be purchased, the price of each, and the total transaction price. The budtender then proceeds to package the products while the customer approaches the touchscreen. The customer see that the total price is $96.39. The customer produces a $100 bill and inserts it into a slot located below the touchscreen. The customer's $100 bill is passed from the slot through a scanner. The scanner identifies that the item is a United States $100 bill, with a serial number D2345678L. The scanner verifies features of a legitimate $100 bill designed to be difficult to counterfeit and certifies the bill as being genuine. The system further verifies the serial number against a database of known items, to confirm, for example, that this bill is not known to be located anywhere else, and/or is not on a list of known stolen bills, and by these cross-checks the bill entering the system is further assured to be legitimate. The scanned information is passed to the system inventory, which creates a new record for the bill in the ITEMS IN PRIMARY REPOSITORY inventory. The bill is then passed into a primary repository located within the counter. In some embodiments of the cash management system, multiple users of the system share certain data in their inventories to permit more robust verification of such things as duplicate serial numbers, customers proffering counterfeit bills, and the like.

The cash management system recognizes that cash has been inserted which is greater than the transaction price. The touchscreen displays a prompt to the customer which reads “Inserted Value: $100. Is this sale final?” and buttons labeled “Yes” and “No”. The customer presses the “Yes” button, verifying the amount inserted and that the sale is to be completed. The cash management system receives the instruction to complete the sale. At that time, the system calculates the amount of change due to the customer to be $3.61. Three $1 bills are retrieved from the primary repository and provided to a scanner. The scanner verifies and records that each bill is a United States $1 bill. The scanner also records each bill's serial number. The serial numbers of the three bills to be dispensed are E1234567K, E1234568K, and E1234569K. This information is transmitted from the scanner to the system inventory. The three $1 bills are provided to the customer through the same slot which the customer had earlier inserted the $100 bill. At the same time, two quarters, one dime, and one penny are dispensed from the fungible asset storage into a change dish located adjacent to the bill slot below the touchscreen. The customer takes the dispensed bills and coins, receives the product from the budtender, and departs the store.

As the change is dispensed, the system inventory updates the records of ITEMS IN PRIMARY REPOSITORY and FUNGIBLE ASSET in accordance with information received from the scanner and data manager. After the completion of the transaction, the system inventory contains the following updated data in the ITEMS IN PRIMARY REPOSITORY and FUNGIBLE ASSET records:

TABLE 6
ITEMS IN PRIMARY REPOSITORY

| Item Type | Item Value | Item Identifiers | | |
|---|---|---|---|---|
| United States | $1 | E1234570K | E1234571K | |
| Bill | | E1234572K | E1234574K | E1234575K |
| | | E1234576K | | |
| United States | $5 | E1234577K | E1234578K | |
| Bill | | | | |
| United States | $10 | E1234579K | E1234580K | E1234581K |
| Bill | | | | |
| United States | $20 | E1234582K | E1234583K | E1234584K |
| Bill | | E1234585K | E1234586K | |
| United States | $50 | E1234587K | E1234588K | |
| Bill | | | | |
| United States | $100 | E1234589K | E1234590K | E1234591K |
| Bill | | E1234592K | E1234593K | E1234594K |
| | | E1234595K | E1234596K | E1234597K |
| | | D2345678L | | |

TABLE 7
FUNGIBLE ASSET

| Item Type | Item Value | Item Count |
|---|---|---|
| United States Quarter | $0.25 | 10 |
| United States Dime | $0.10 | 21 |
| United States Nickel | $0.05 | 8 |
| United States Penny | $0.01 | 63 |
| Total on Hand | $5.63 | 102 |

The BUNDLES and BRICKS records remain unchanged because no bundles or bricks were involved in the transaction.

Following the transaction, the system recognizes that there are ten $100 bills in the primary repository. The system has previously been programmed to create a bundle of ten $100 bills when such items are present in the primary repository, as they are not needed for customer transactions. The system sends the command to create a bundle. Within the primary repository, a device retrieves a $100 bill and passes it to a scanner. The scanner verifies and records that the bill is a US $100 bill. The scanner further records the serial number of the bill. Following scanning, the bill is provided to a cash bundling system integrated in the counter below the primary repository. This process is repeated until ten $100 bills have been provided to the cash bundling system. The cash bundling system then bundles the bills and attaches a physical DSPID to the bundle by stamping a barcode on the paper that wraps the bills. The bundle is dropped out of the cash bundling system into a secondary repository located directly below the counter containing the primary repository.

Simultaneously with the command to create a bundle, the system inventory creates a new bundle. This new bundle is assigned the DSPID YZ579. As each bill to be included in the bundle is scanned, the serial number of the bill is entered into the record of items within the bundle. The items are removed from the records of cash in the primary repository. After the bundling process is completed, the system inventory contains the following data:

TABLE 8
ITEMS IN PRIMARY REPOSITORY

| | Item | | | |
|---|---|---|---|---|
| Item Type | Value | Item Identifiers | | |
| United | $1 | E1234570K | E1234571K | E1234572K |
| States Bill | | E1234574K | E1234575K | E1234576K |
| United | $5 | E1234577K | E1234578K | |
| States Bill | | | | |
| United | $10 | E1234579K | E1234580K | E1234581K |
| States Bill | | | | |
| United | $20 | E1234582K | E1234583K | E1234584K |
| States Bill | | E1234585K | E1234586K | |
| United | $50 | E1234587K | E1234588K | |
| States Bill | | | | |

TABLE 9
BUNDLES

| | | Bundle Contents | | | | |
|---|---|---|---|---|---|---|
| | | Item | Item | | | |
| DSPID | Value | Type | Value | Item Identifiers | | |
| AA123 | $100 | United | $20 | E9876543M | E9876542M | E9876541M |
| | | States | | E9876539M | E9876538M | |
| | | Bill | | | | |
| AB567 | $20 | United | $1 | E4563219K | E4563218K | E4563217K |
| | | States | | E4563216K | E4563215K | E4563214K |
| | | Bill | | E4563213K | E4563212K | E4563211K |
| | | | | E4563210K | E4563209K | E4563208K |
| | | | | E4563207K | E4563206K | E4563205K |
| | | | | E4563204K | E4563203K | E4563202K |
| | | | | E4563201K | E4563200K | |
| YZ579 | $1000 | United | $100 | E1234589K | E1234590K | E1234591K |
| | | States | | E1234592K | E1234593K | E1234594K |
| | | Bill | | E1234595K | E1234596K | E1234597K |
| | | | | D2345678L | | |

The FUNGIBLE ASSET and BRICKS records remain unchanged because no fungible asset or bricks were involved in the action.

Sometime following the transaction and bundling, the dispensary manager is reviewing the system inventory records from a computer in the manager's officer. The manager notices that there are only six $1 bills in the primary repository available for making change. The manager decides this level is insufficient. The manager tells the system to unpackage bundle AB567 and have the bills within made available in the primary repository. Within the secondary repository, a device locates bundle AB567 by its DSPID, which consists of a QR code stamped on the paper which wraps the bills together. Once the device locates the bundle, it is provided back to the cash bundling system. The cash bundling system unbundles AB567 and passes the now-free bills to the primary repository. At the same time, the system inventory adds the records of bills contained in AB567 to the ITEMS IN PRIMARY REPOSITORY inventory. The system inventory then removes bundle AB567 from the BUNDLES records.

Following the unbundling, the system inventory contains the following updated data:

TABLE 10
ITEMS IN PRIMARY REPOSITORY

| Item Type | Item Value | Item Identifiers | | |
|---|---|---|---|---|
| United | $1 | E1234570K | E1234571K | E1234572K |
| States Bill | | E1234574K | E1234575K | E1234576K |
| | | E4563219K | E4563218K | E4563217K |
| | | E4563216K | E4563215K | E4563214K |
| | | E4563213K | E4563212K | E4563211K |
| | | E4563210K | E4563209K | E4563208K |
| | | E4563207K | E4563206K | E4563205K |
| | | E4563204K | E4563203K | E4563202K |
| | | E4563201K | E4563200K | |
| United | $5 | E1234577K | E1234578K | |
| States Bill | | | | |
| United | $10 | E1234579K | E1234580K | E1234581K |
| States Bill | | | | |
| United | $20 | E1234582K | E1234583K | E1234584K |
| States Bill | | E1234585K | E1234586K | |
| United | $50 | E1234587K | E1234588K | |
| States Bill | | | | |

TABLE 11
BUNDLES

| | | Bundle Contents | | | | |
|---|---|---|---|---|---|---|
| | | Item | Item | | | |
| DSPID | Value | Type | Value | Item Identifiers | | |
| AA123 | $100 | United | $20 | E9876543M | E9876542M | E9876541M |
| | | States | | E9876539M | E9876538M | |
| | | Bill | | | | |
| YZ579 | $1000 | United | $100 | E1234589K | E1234590K | E1234591K |
| | | States | | E1234592K | E1234593K | E1234594K |
| | | Bill | | E1234595K | E1234596K | E1234597K |
| | | | | D2345678L | | |

The FUNGIBLE ASSET and BRICKS records remain unchanged because no fungible asset or bricks were involved in the transaction.

Sometime after the unbundling, a vendor arrives at the dispensary. The vendor meets with the dispensary manager and provides the manager an invoice for product delivered. The invoice is for $1500. The manager decides to fulfil the invoice by transferring to the vendor $1000 in the form of bundle YZ579 and $500 in the form of brick B987Z. The manager enters into the system that bundle YZ579 is to be removed from the system for a vendor payment. The manager enters a withdrawal authorization code and confirms the withdrawal. The manager goes to the secondary repository, which is opened as a result of the authorization code. The manager finds bundle YZ579, identified by the DSPID number printed on the cash wrapping, and removes it from the secondary repository. The manager closes the secondary repository after removing bundle YZ579. The manager hands bundle YZ579 to the vendor. At the same time, the system inventory removes the records of bundle YZ579 and the bills that were contained in it from the BUNDLES inventory. The system inventory creates a new record in a TRANSACTION HISTORY inventory for the vendor payment. The system inventory records that bundle YZ579 and the bills within have been given to the vendor. In an alternative embodiment, the manager simply enters a “withdrawal needed” of $1500 and the system selects the relevant bundles having a total value of $1500. The bundles are delivered through a bundle output port and the serial numbers of all items in the delivered bundles are removed from the inventory.

After providing bundle YZ579 to the vendor, the manager returns to his computer. The invoice provides a digital address corresponding to the vendor's instance of the cash management system. The manager enters this address in the user interface and indicates that payment is to be made to the address. The manager inputs that brick B987Z is to be transferred to the vendor. The manager authorizes and confirms this transaction. The dispensary's system inventory transfers to the vendor's system inventory the SSPID and digital key corresponding to B987Z, as well as the records of bundles and bills contained within B987Z. The dispensary's system inventory removes the record of B987Z and the bundles and bills contained within from the BRICKS inventory. The vendor's system inventory adds the record of B987Z and the bundles and bills within to its BRICKS inventory. The dispensary's system inventory updates the record of the transaction in the TRANSACTION HISTORY inventory to reflect that brick B987Z and the bundles and bills contained within was transferred as part of the transaction with the vendor. The vendor's system inventory creates a new record in its TRANSACTION HISTORY indicating receipt of the bundle and brick as payment for the invoice.

In accordance with the dispensary's practice, brick B987Z and other bricks created by dispensary are stored in a warehouse operated by a third party. The third party operates the warehouse specifically as a secure storage location for bricks. The dispensary's system inventory transmits to the vendor's system inventory the fact that brick B987Z is physically located in said warehouse. The vendor also uses this third-party warehouse, in addition to its own local brick storage locations. Because the vendor does not immediately require the cash within brick B987Z, the vendor can allow it to remain in the warehouse for collateral in a future transaction. Upon confirmation that brick B987Z's information has been transferred to vendor's system inventory, the vendor completes delivery of the product and leaves the dispensary.

Following the vendor transaction, the dispensary's system inventory contains the following data:

TABLE 12
ITEMS IN PRIMARY REPOSITORY

| Item Type | Item Value | Item Identifiers | | |
|---|---|---|---|---|
| United | $1 | E1234570K | E1234571K | E1234572K |
| States Bill | | E1234574K | E1234575K | E1234576K |
| | | E4563219K | E4563218K | E4563217K |
| | | E4563216K | E4563215K | E4563214K |
| | | E4563213K | E4563212K | E4563211K |
| | | E4563210K | E4563209K | E4563208K |
| | | E4563207K | E4563206K | E4563205K |
| | | E4563204K | E4563203K | E4563202K |
| | | E4563201K | E4563200K | |
| United | $5 | E1234577K | E1234578K | |
| States Bill | | | | |
| United | $10 | E1234579K | E1234580K | E1234581K |
| States Bill | | | | |
| United | $20 | E1234582K | E1234583K | E1234584K |
| States Bill | | E1234585K | E1234586K | |
| United | $50 | E1234587K | E1234588K | |
| States Bill | | | | |

TABLE 13
FUNGIBLE ASSET

| Item Type | Item Value | Item Count |
|---|---|---|
| United States Quarter | $0.25 | 10 |
| United States Dime | $0.10 | 21 |
| United States Nickel | $0.05 | 8 |
| United States Penny | $0.01 | 63 |
| Total on Hand | $5.63 | 102 |

TABLE 14
BUNDLES

| | | Bundle Contents | | | | |
|---|---|---|---|---|---|---|
| | | Item | Item | | | |
| DSPID | Value | Type | Value | Item Identifiers | | |
| AA123 | $100 | United | $20 | E9876543M | E9876542M | E9876541M |
| | | States | | E9876539M | E9876538M | |
| | | Bill | | | | |

TABLE 15
BRICKS

| | | Brick Contents | | | | |
|---|---|---|---|---|---|---|
| SSPID | Value | DSPID | Value | Bundle Contents | | |
| | | | | Item | Item | Item Identifiers |
| | | | | Type | Value | |
| | | | | Item | Item | Item Identifiers |
| | | | | Type | Value | |
| | | | | Item | Item | Item Identifiers |
| | | | | Type | Value | |

The BRICKS inventory is empty.

TABLE 16
TRANSACTION HISTORY
Transaction 141
. . .
Transaction 142
. . .
Transaction 143
Type: Invoice Payment
To: Vendor
Date: Jul. 25, 2019
Items Transferred:

| | | Bundle Contents | | | | | |
|---|---|---|---|---|---|---|---|
| | | Item | Item | | | | |
| DSPID | Value | Type | Value | Item Identifiers | | | |
| YZ579 | $1000 | United | $100 | E1234589K | E1234590K | E1234591K | |
| | | States | | E1234592K | E1234593K | E1234594K | |
| | | Bill | | E1234595K | E1234596K | E1234597K | |
| | | | | D2345678L | | | |
| | | Brick Contents | | | | | |
| | | | | Bundle Contents | | | |
| | | | | Item | Item | | |
| SSPID | Value | DSPID | Value | Type | Value | Item Identifiers | |
| B987Z | $500 | XY234 | $100 | United | $20 | C2468135M | C2468136M |
| | | | | States | | C2468137M | C2468138M |
| | | | | Bill | | C2468139M | |
| | | AK470 | $100 | United | $20 | C2468140M | C2468141M |
| | | | | States | | C2468142M | C2468143M |
| | | | | Bill | | C2468144M | |
| | | DU093 | $100 | United | $20 | C2468145M | C2468146M |
| | | | | States | | C2468147M | C2468148M |
| | | | | Bill | | C2468149M | |
| | | GJ213 | $100 | United | $20 | C2468150M | C2468151M |
| | | | | States | | C2468152M | C2468153M |
| | | | | Bill | | C2468154M | |
| | | TR346 | $100 | United | $20 | C2468155M | C2468156M |
| | | | | States | | C2468157M | C2468158M |
| | | | | Bill | | C2468159M | |

Following the transaction, the following records are added to the vendor's system inventory:

TABLE 17
BUNDLES

| | | Bundle Contents | | | | |
|---|---|---|---|---|---|---|
| | | Item | Item | | | |
| DSPID | Value | Type | Value | Item Identifiers | | |
| YZ579 | $1000 | United | $100 | E1234589K | E1234590K | E1234591K |
| | | States | | E1234592K | E1234593K | E1234594K |
| | | Bill | | E1234595K | E1234596K | E1234597K |
| | | | | D2345678L | | |

TABLE 18
BRICKS

| | | Brick Contents | | | | | |
|---|---|---|---|---|---|---|---|
| | | | | Bundle Contents | | | |
| | | | | Item | Item | | |
| SSPID | Value | DSPID | Value | Type | Value | Item Identifier | |
| B987Z | $500 | XY234 | $100 | United | $20 | C2468135M | C2468136M |
| | | | | States | | C2468137M | C2468138M |
| | | | | Bill | | C2468139M | |
| | | AK470 | $100 | United | $20 | C2468140M | C2468141M |
| | | | | States | | C2468142M | C2468143M |
| | | | | Bill | | C2468144M | |
| | | DU093 | $100 | United | $20 | C2468145M | C2468146M |
| | | | | States | | C2468147M | C2468148M |
| | | | | Bill | | C2468149M | |
| | | GJ213 | $100 | United | $20 | C2468150M | C2468151M |
| | | | | States | | C2468152M | C2468153M |
| | | | | Bill | | C2468154M | |
| | | TR346 | $100 | United | $20 | C2468155M | C2468156M |
| | | | | States | | C2468157M | C2468158M |
| | | | | Bill | | C2468159M | |

The vendor's system inventory now reflects that it possesses title to the cash in the bundle and brick, even though vendor only possesses the physical cash in the bundle. The general principles embodied in this example can be repeated, altered, or expanded to carry out transactions and transfers of funds between a plurality of businesses. Each business can install and integrate an instance of the system, which is capable of communicating with other instances belonging to other businesses. In the above example, the system inventories of the dispensary and vendor can also be linked to an instance possessed by the third-party warehouse operator, who retains an additional record of the transaction and the bricks, bundles, and bills involved, thereby increasing validity, transparency, and security. In the example above, any of the parties to the transaction can record the transaction and identities of the bricks, bundles, and bills involved in a blockchain ledger for security and verification purposes.

### Example 2

The following example demonstrates the use of the present invention in a casino setting. Primary Repository A is a chip exchanger located on the casino floor, which is connected to other chip exchangers within the casino through a central chip vault. The chips in the casino have RFID chips embedded within them which identify the chip and the casino to which it belongs.

At 7:00 pm, the Royale Casino's system inventory contains the following data:

TABLE 19
ITEMS IN PRIMARY REPOSITORY A

| Item | Item | | | |
|---|---|---|---|---|
| Type | Value | Item Identifier | | |
| United | $10 | U3217890P | U3217891P | U3217892P |
| States | | | | |
| Bill | | | | |
| United | $20 | U3217893P | U3217894P | U3217895P |
| States | | U3217896P | U3217897P | |
| Bill | | | | |
| United | $50 | U3217898P | U3217899P | |
| States | | | | |
| Bill | | | | |
| United | $100 | U3217900P | U3217901P | U3217902P |
| States | | | | |
| Bill | | U3217903P | U3217904P | |
| Royale | $5 | RCT334 | RCT335 | RCT336 |
| Chip | | | | |
| Royale | $10 | RCT337 | RCT338 | |
| Chip | | | | |
| Royale | $25 | RCT339 | RCT340 | RCT341 |
| Chip | | RCT342 | RCT343 | RCT344 |
| Royale | $50 | RCT345 | RCT346 | |
| Chip | | | | |
| Royale | $100 | RCT347 | RCT348 | RCT349 |
| Chip | | | | |
| Royale | $250 | RCT350 | RCT351 | |
| Chip | | | | |
| Royale | $500 | RCT352 | RCT353 | |
| Chip | | | | |

TABLE 20
BUNDLES

| | | Bundle Contents | | | | |
|---|---|---|---|---|---|---|
| | | Item | Item | | | |
| DSPID | Value | Type | Value | Item Identifier | | |
| DD345 | $1000 | United | $100 | Y4928475C | Y4928476C | Y4928477C |
| | | States | | Y4928478C | Y4928479C | Y4928480C |
| | | Bill | | Y4928481C | Y4928482C | Y4928483C |
| | | | | Y4928484C | | |
| DE837 | $2500 | United | $100 | Y4928485C | Y4928486C | Y4928487C |
| | | States | | Y4928488C | Y4928489C | Y4928490C |
| | | Bill | | Y4928491C | Y4928492C | Y4928493C |
| | | | | Y4928494C | Y4928495C | Y4928496C |
| | | | | Y4928497C | Y4928498C | Y4928499C |
| | | | | Y4928500C | Y4928501C | Y4928502C |
| | | | | Y4928503C | Y4928504C | Y4928505C |
| | | | | Y4928506C | Y4928507C | Y4928508C |
| | | | | Y4928509C | | |
| FE264 | $2500 | United | $100 | Y4928510C | Y4928511C | Y4928512C |
| | | States | | Y4928513C | Y4928514C | Y4928515C |
| | | Bill | | Y4928516C | Y4928517C | Y4928518C |
| | | | | Y4928519C | Y4928520C | Y4928521C |
| | | | | Y4928522C | Y4928523C | Y4928524C |
| | | | | Y4928525C | Y4928526C | Y4928527C |
| | | | | Y4928528C | Y4928529C | Y4928530C |
| | | | | Y4928531C | Y4928532C | Y4928533C |
| | | | | Y4928534C | | |
| RG746 | $5000 | Royale | $500 | RCX984 | RCX985 | RCX986 |
| | | Chip | | RCX987 | RCX988 | RCX989 |
| | | | | RCX990 | RCX991 | RCX992 |
| | | | | RCX993 | | |

TABLE 21
BRICKS

| | | Brick Contents | | | | | |
|---|---|---|---|---|---|---|---|
| | | | | Bundle Contents | | | |
| | | | | Item | Item | | |
| SSPID | Value | DSPID | Value | Type | Value | Item Identifier | |
| B800Z | $500 | XY234 | $100 | United | $20 | T2468543R | T2468544R |
| | | | | States | | T2468545R | T2468546R |
| | | | | Bill | | T2468547R | |
| | | AK470 | $100 | United | $20 | T2468548R | T2468549R |
| | | | | States | | T2468550R | T2468551R |
| | | | | Bill | | T2468552R | |
| | | DU093 | $100 | United | $20 | T2468553R | T2468554R |
| | | | | States | | T2468555R | T2468556R |
| | | | | Bill | | T2468557R | |
| | | GJ213 | $100 | United | $20 | T2468558R | T2468559R |
| | | | | States | | T2468560R | T2468561R |
| | | | | Bill | | T2468562R | |
| | | TR346 | $100 | United | $20 | T2468563R | T2468564R |
| | | | | States | | T2468565R | T2468566R |
| | | | | Bill | | T2468567R | |

TABLE 22
TRANSACTION HISTORY

Transaction 6892
. . .
Transaction 6893

A casino patron approaches the chip exchanger, looking to cash out their winnings. The chip exchanger has a slot located on the exterior capable of accepting casino chips. The customer inserts their chips: two $25 Royale chips, three $10 Royale chips, and a $50 chip belonging to the nearby Star casino. The chip exchanger has a small screen which displays the value of the chips inserted. Each chip is passed from the slot to an RFID scanner, which scans the value and identifier of the Royale chips (RCL245, RCL246, and RCL247 for the $10 chips, and RCS756 and RCS788 for the $25 chips). The Royale chips are then deposited in the chip exchanger's chip reserves. The Star chip does not contain an RFID. When the RFID scanner fails to recognize a signature from the Star chip, the Star chip is diverted to a separate optical scanner. The optical scanner recognizes that the chip is issued by Star. Because Royale does not recognize or exchange Star chips, the Star chip is provided back to the patron through the chip slot. The screen displays an error message indicating to the patron that this chip is not accepted at the Royale Casino.

As each chip is scanned, the system inventory is updated to indicate that the chip is now contained within the primary repository of the chip exchanger. The system adds the total value of the inserted Royale chips to determine how much value must be dispensed to the patron. After calculating that the patron is owed $80, the system retrieves from the primary repository one $50 bill, one $20 bill, and one $10 bill. Each bill is provided to the optical scanner, which verifies the value of each bill and records the serial numbers of each bill (in this case U3217898P for the $50 bill, U3217893P for the $20 bill, and U3217891P for the $10 bill). The three bills are dispensed through a separate bill slot on the exterior of the chip exchanger. The patron takes the bills and the returned Star chip and leaves. The system inventory is updated to reflect the removal of the three bills that were dispensed.

Following the patron's cashing out, the system inventory contains the following updated data:

TABLE 23
ITEMS IN PRIMARY REPOSITORY A

| Item | Item | | | |
|---|---|---|---|---|
| Type | Value | Item Identifier | | |
| United | $10 | U3217890P | | U3217892P |
| States | | | | |
| Bill | | | | |
| United | $20 | | U3217894P | U3217895P |
| States | | | | |
| Bill | | U3217896P | U3217897P | |
| United | $50 | | U3217899P | |
| States | | | | |
| Bill | | | | |
| United | $100 | U3217900P | U3217901P | U3217902P |
| States | | | | |
| Bill | | U3217903P | U3217904P | |
| Royale | $5 | RCT334 | RCT335 | RCT336 |
| Chip | | | | |
| Royale | $10 | RCT337 | RCT338 | |
| Chip | | RCL245 | RCL246 | RCL247 |
| Royale | $25 | RCT339 | RCT340 | RCT341 |
| Chip | | RCT342 | RCT343 | RCT344 |
| | | RCS756 | RCS788 | |
| Royale | $50 | RCT345 | RCT346 | |
| Chip | | | | |
| Royale | $100 | RCT347 | RCT348 | RCT349 |
| Chip | | | | |
| Royale | $250 | RCT350 | RCT351 | |
| Chip | | | | |
| Royale | $500 | RCT352 | RCT353 | |
| Chip | | | | |

TABLE 24
TRANSACTION HISTORY

Transaction 6892
. . .
Transaction 6893
. . .
Transaction 6894
Type: Cashout
Date: August 6, 2019
Time: 7:03 pm
Received:

| Item Type | Item | | | |
|---|---|---|---|---|
| | Value | Item Identifiers | | |
| Royale Chip | $10 | RCL245 | RCL246 | RCL247 |
| Royale Chip | $25 | RCS756 | RCS788 | |

Dispensed:

| Item Type | Item Value | Item Identifiers |
|---|---|---|
| United States Bill | $10 | U3217891P |
| United States Bill | $20 | U3217893P |
| United States Bill | $50 | U3217898P |

The BUNDLES and BRICKS records are not changed because no bundles or bricks were involved in the transaction.

The system issues a command to form a $5,000 brick using bundles FE264 and DE837. Within the casino's secondary repository, a device locates both bundles by scanning the DSPID printed on the side of the money wrapping. The bundles are retrieved by the device and placed into a high-strength composite material box, which is to serve as the brick. The box further contains an embedded circuit board and transmitter. The exterior of the box contains a 0-9 numeric keypad. The box is capable of locking securely and is only able to be unlocked by entering the proper code on the keypad. At the same time, the data manager assigns the new brick the identity C028P, and assigns a key, which is 8675309. The new brick's SSPID and key are transmitted to the circuit in the brick box. The box is then closed and locked. At this point, it can only be opened by entering 8675309 on the keypad. The system inventory then creates a new brick with identity C028P in the BRICKS inventory, and associates with the brick record the data on the bundles and items contained within it. The system inventory then removes DE837 and FE264 from the BUNDLES inventory. The physical brick is moved to a secure location in the casino's vault.

Following the formation of the new brick, the system inventory contains the following updated information:

TABLE 25
BUNDLES

| | | Bundle Contents | | | | |
|---|---|---|---|---|---|---|
| | | Item | Item | | | |
| DSPID | Value | Type | Value | Item Identifier | | |
| DD345 | $1000 | United | $100 | Y4928475C | Y4928476C | Y4928477C |
| | | States | | Y4928478C | Y4928479C | Y4928480C |
| | | Bill | | Y4928481C | Y4928482C | Y4928483C |
| | | | | Y4928484C | | |
| RG746 | $5000 | Royale | $500 | RCX984 | RCX985 | RCX986 |
| | | Chip | | RCX987 | RCX988 | RCX989 |
| | | | | RCX990 | RCX991 | RCX992 |
| | | | | RCX993 | | |

TABLE 26
BRICKS

| | | Brick Contents | | | | | |
|---|---|---|---|---|---|---|---|
| | | | | Bundle Contents | | | |
| | | | | Item | Item | | |
| SSPID | Value | DSPID | Value | Type | Value | Item Identifier | |
| B800Z | $500 | XY234 | $100 | United | $20 | T2468543R | T2468544R |
| | | | | States | | T2468545R | T2468546R |
| | | | | Bill | | T2468547R | |
| | | AK470 | $100 | United | $20 | T2468548R | T2468549R |
| | | | | States | | T2468550R | T2468551R |
| | | | | Bill | | T2468552R | |
| | | DU093 | $100 | United | $20 | T2468553R | T2468554R |
| | | | | States | | T2468555R | T2468556R |
| | | | | Bill | | T2468557R | |
| | | GJ213 | $100 | United | $20 | T2468558R | T2468559R |
| | | | | States | | T2468560R | T2468561R |
| | | | | Bill | | T2468562R | |
| | | TR346 | $100 | United | $20 | T2468563R | T2468564R |
| | | | | States | | T2468565R | T2468566R |
| | | | | Bill | | T2468567R | |
| C028P | $5000 | DE837 | $2500 | United | $100 | Y4928485C | Y4928486C |
| | | | | States | | Y4928487C | Y4928488C |
| | | | | Bill | | Y4928489C | Y4928490C |
| | | | | | | Y4928491C | Y4928492C |
| | | | | | | Y4928493C | Y4928494C |
| | | | | | | Y4928495C | Y4928496C |
| | | | | | | Y4928497C | Y4928498C |
| | | | | | | Y4928499C | Y4928500C |
| | | | | | | Y4928501C | Y4928502C |
| | | | | | | Y4928503C | Y4928504C |
| | | | | | | Y4928505C | Y4928506C |
| | | | | | | Y4928507C | Y4928508C |
| | | | | | | Y4928509C | |
| | | FE264 | $2500 | United | $100 | Y4928510C | Y4928511C |
| | | | | States | | Y4928512C | Y4928513C |
| | | | | Bill | | Y4928514C | Y4928515C |
| | | | | | | Y4928516C | Y4928517C |
| | | | | | | Y4928518C | Y4928519C |
| | | | | | | Y4928520C | Y4928521C |
| | | | | | | Y4928522C | Y4928523C |
| | | | | | | Y4928524C | Y4928525C |
| | | | | | | Y4928526C | Y4928527C |
| | | | | | | Y4928528C | Y4928529C |
| | | | | | | Y4928530C | Y4928531C |
| | | | | | | Y4928532C | Y4928533C |
| | | | | | | Y4928534C | |

The ASSET ITEMS IN PRIMARY REPOSITORY A records are not changed because those items were not involved in the transaction. The TRANSACTIONS inventory is not changed because the casino does not record internal movements of cash to that database.

### Example 3

A convenience store implements the cash management system of the present invention. Records and inventory are maintained in a manner similar to those shown in Examples 1 and 2. Because the store has only limited space to retain cash, and for security reasons, the store has implemented procedures to deposit unneeded cash with its bank. The first step of this procedure is bundling cash periodically throughout the day. The store is open 24 hours a day, so it has decided to bundle cash in excess of a defined amount to always be retained in the register at 10:00 am and 8:00 pm. When these bundles are created, their DSPIDs and contents are transmitted to the store's bank. This transmission is encrypted and verified by blockchain technology. Thus, whenever a bundle is created, both the store and the bank are simultaneously made aware of the cash value and asset items that the store possesses.

The store contracts with an armored car company to pick up the bundles every other day. At pickup time, the store manager enters a pickup code into the user interface. This permits the manager and armored car driver to retrieve the bundles from the secondary repository, which is a safe built into the floor under the register counter. Additionally, the store manager provides to the armored car driver an inventory printout that lists all bundles to be deposited, including the DSPIDs of said bundles. The armored car takes the bundles and the inventory printout to the store's bank.

At the bank, the inventory printout is verified against the list of bundles previously transmitted to the bank. If the bank already has data on the bundle, the bundle is scanned into the bank's system, noted to be in the bank's physical possession, and secured within the bank's physical vault. If the bank does not have data on the bundle, the bank sends a request to the store for data associated with each DSPID it does not recognize. Once the store provides information associated with the unknown bundle, the bank treats it as discussed above. Optionally, the bank may transmit confirmation to the store that each bundle has been received, recorded, and physically stored in the bank vault.

### Example 4

The Royale Casino implements the cash management system of the present invention. Records and inventory are maintained in a manner similar to Examples 1 and 2. The casino retains large amounts of cash, in loose form as well as within bundles and bricks kept in the casino vault. The casino also finds that it needs to transfer cash to its bank to facilitate business needs. To accomplish this in a secure manner, the casino has decided to create bricks specifically designated for transfer to a bank. When a transfer is needed, the casino first identifies bundles and bricks that are to be sent to the bank for deposit. In this case, the casino selects ten bundles, each with value of $2,500, to deposit $25,000 in the bank. The casino also selects five bricks, two with value $50,000 and three with value $10,000, to deposit $130,000 in the bank.

The selected bundles are enclosed within a brick package, which is then assigned a the SSPID and given an access key by the system inventory. The selected bricks are similarly enclosed within a brick package, assigned an SSPID and access key. The system inventory alerts the bank of an incoming transfer and transmits the SSPIDs and access codes through an encrypted, blockchain verified communication. The bank acknowledges that the transfer is incoming. A courier for the casino securely and discretely physically transfers the two new bricks to the bank.

The SSPIDs of all new bricks are confirmed at the bank to verify that they are the correct bricks for the transfer. Once the brick's identity is confirmed, the bank uses the encrypted access/unlock keys to open each brick. This signals to the bank and casino's system inventory that the brick has been destroyed and is no longer valid as a system record. The bank takes the bundles from the first new brick, scans the DSPID for each bundle into its own system, and physically secures them in its vault. In some embodiments the data transmitted to the bank include the DSPID of every bundle in every brick. Thus when a brick is destroyed by opening, the data previously associated with the brick's single SSPID becomes data associated with DSPIDs of the various bundles that had been contained in the brick. The bank takes the bricks that were used to create the second new brick and scans them into its own system, then physically secures them in its vault for its own future use. The courier takes the two brick packages that previously contained the new bricks back to the casino so that they can be reused to create new transfer bricks for a future bank deposit.

### Example 4

The Royale Casino implements the asset management system of the present invention. For the sake of this example, there is a user named Roger, who is a gambler at The Royale Casino owned or managed by Carlos. At Carlos's casino, there is a system machine on the floor, which is present in part to make sure that people in the casino don't go out of the casino to the local pawn shop and sell their things over there and get cash. Roger, who is gambling, just ran out of money and decides to give his car title to the casino. Roger retrieves his car title from his safe in his room, goes to the machine in the casino, follows the registration authentication process, to upload personal details about the user to the system machine.

Just like at an ATM, Roger inserts the title into the system machine (there might be envelopes and things to standardize the insertion implementation). Roger inserts the item in the system, which then takes this physical piece of information and slots it, giving it a unique identity within the system.

This all occurs offline, and the system provides a receipt back to the user (Roger) that can have a QR code that the user can use to read or scan onto the system or another system on the network. In the casino environment, the system can offer Roger casino chips in exchange for the asset he just inserted. Roger being a gambler, of course wants chips rather than cash and selects “YES”. The system can instruct Roger to hold up his receipt with the QR code to scan it. The system then receives and digitizes that asset and puts it on a digital ledger, such as a blockchain.

The system records the value of the title, but the value of the title is no longer under Roger's control. The title and its value is recorded on a digital ledger which cannot be falsified. The digital ledger is now the custodian of the digital asset (the digitized car title). That digital asset now is under the control of the casino, which has the keys to the ledger for the digital asset.

Carlos doesn't care about collecting car titles, and instead wants to sell the title to someone. Carlos has connections with the local used-car dealership who can offer to sell any used car for which the casino has the title through the system. Carlos can therefore readily find a buyer for that car title. Carlos need not to give Roger the money, since the value is in the ledger, and the digitized asset is controlled by Carlos as the owner of the casino housing the system.

In a related example, Carlos needs to decide if he is going to give Roger his value or not. For example, the car may not be in great shape and may have a value of e.g., $4,000. When Carlos takes possession of the digitized asset, he isn't really worried too much about his ability to resell it, so he buys it. Carlos is taking the risk of this asset before finding the final buyer. Carlos now takes possession of that physical title, which he is allowed to do because he has the keys to the ledger that controls the keys to the physical asset. Carlos informs the system that he is the new owner. Carlos can then take it across town to his buyer, who gives Carlos money and takes custody and real legal ownership of the car. Carlos then gives Roger the value that Roger wanted for the car. Roger acknowledges payment from Carlos, in the form of a signature. Acknowledgement of payment can be done digitally on the system, so that the user can input their signature, type in a user pin, etc. Alternatively, because there is a scanner on the machine, the payment acknowledgment can be a physical signature on a casino letterhead where Roger acknowledges full transfer of all rights of his car title. Roger then receives $4,000 worth of chips. The signature document can be scanned back into the system, where it can be tied to the digital asset to prove to the next buyer that Carlos is the new owner.

### Example 5

In another example related to the scenario of Example 4, Roger shows up to the system with his car title, and he puts the car title in an envelope and scans the envelope into the machine. The machine takes the envelope, scans the car title uniquely, hashes it, digitizes it, and creates an NFT from the information on the car title; this can include taking a picture of the title and/or a picture of the user in front of the machine and any other aspects of it. An NFT is created with all that information.

Now, there is a unique digital twin of the physical car title which is then put into the casino's digital asset repository. The digital asset repository is a database of digital assets in NFT form, typically in blockchain, which looks like a digital wallet and is where the keys controlling ownership of the NFTs are located. Right now, there's only Roger, the user, and the system machine. Whoever owns the system machine owns, at that moment, the keys to this digital asset repository. The digital twin of Roger's title to the car is currently owned or controlled by the controller of the database, the digital asset repository, such as Carlos, the casino owner. The casino prefers to monetize the car title because that is not their area of business. The casino needs to sell that asset and get the best value for it.

A good way to monetize an asset is via a marketplace or auction house. The casino can take a subset of the digital assets in their digital asset repository and put them online for sale. The casino can list the assets on a website like eBay. A list of assets that are available for sale are posted, and buyers would then be invited to come into the auction house or marketplace and look at what's available and make bids on them.

Once a winning bid is selected, two things will happen. For example, in the case of Roger's car, the seller is going to want money from the buyer and the buyer is going to want to receive the car title, which entitles control of the real asset, not just the digital one. As part of that, the winning bid, the buyer now will receive new levels of control over the system process. The buyer who has won the auction or executed the purchase in Carlos's casino marketplace or auction house wants the title. With their winning bid or purchase price, the buyer will be able to instruct the system where to send the asset. Hence, the buyer has the digital keys to instruct the system network to send the asset. At this point, the buyer could be in New York, but is logged in to the auction house or marketplace, which can be a web interface that will connect to this network. Through that interface, the buyer is able to tell the owner, the current owner of the digital asset, which is still the casino, to transfer the asset to the buyer.

Carlos will have control over the transfer, such as asking the buyer to update their address on their profile so the asset can be sent to them. Then, the physical asset can be transferred to the buyer, at their stated address of location. Once the asset has left the casino warehouse, or some other triggering event, then the payment can be initiated. The system has the smart contract encoded in it. Essentially, Roger, the person who has put the car title in the machine, will then receive that payment, accept the payment, sign a receipt, and the buyer signs a receipt that the item is received, along with the value, and the cycle is complete.

### Example 6

In another example related to the scenario of Example 4, a potentially simpler cycle can be envisaged for potentially even, for example, scenarios where the casino is willing to take the risk of owning the digitized asset. This has no risk to Carlos, only to the casino in the sense the money does not move until buyers are found, although that might not always be the right flow for a casino. And again, the casino can transfer value towards Roger or a user whenever they want to, with the casino taking on the risk at that point. To entice Roger to use the system, the casino may for example provide value in the form of cash or chips immediately but will go find a buyer later; that would be up to the discretion of the casino, who now own the digitized asset.

Hence, both flows are possible and both flows are described, i.e., wherein the user selling the asset (Carlos) receives an earlier or immediate payment, and wherein the user selling the asset (Carlos) receives a payment at a later time, once a buyer has been found for the asset.

The foregoing examples are provided for illustrative purposes and are not to be construed to represent the sole or entire embodiment of the invention. Within the data manager and system inventory, further records can be created or maintained, and the foregoing examples should not be construed to limit the types, sizes, formats, indexes, or other traits of the inventory, sub-inventory, or records.

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that can have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

What is claimed is:

1. A asset-management system that provides on-location cryptographically secure asset digitization, adapted for handling of one or more items of at least one asset type, the system comprising:
a user interface;
an intake portal adapted to: a) receive documented evidence of one or more assets, and b) capture or assign a unique identifier for the asset;
a processor adapted to receive, process, and transmit said asset unique identifier;
a cryptographically secure immutable digital asset ledger for storing documented evidence of the asset;
and a means of providing a cryptographically unique proof of record.

2. The system of claim 1, wherein the asset comprises one or more selected from currency, digital currency, non-fungible tokens, legal instruments, stocks, bonds, intellectual property, art, tickets, coupons, tokens, notes, banking accounts, digital currency wallets, contracts, promissory notes, private keys, public keys, or any item with documentable value.

3. The system of claim 1, wherein the asset is self-validating.

4. The system of claim 1, wherein the asset is not self-validating and wherein documented evidence of the asset comprises more than one form of documentation for verification of a user and/or the asset.

5. The system of claim 1, wherein the documented asset evidence comprises one or more selected from physical identification, biometric data, witness evidence, multimedia evidence, bank statements, legal documents, chain of title and/or provenance, reputation score, and/or any physical documentation relating to the user and/or the asset.

6. The system of claim 1, wherein the user interface and the intake portal are present on a single device.

7. The system of claim 1, wherein the user interface and the intake portal are present on separate devices.

8. The system of claim 1, wherein the user interface is implemented by an interaction between a machine and a user.

9. The system of claim 1, wherein the user interface comprises an app for a mobile device, a camera, a screen, a computer program, or a physical key.

10. The system of claim 1, wherein the intake portal comprises one or more types of document imaging technology to provide the system with documented evidence of an asset.

11. The system of claim 1, wherein the intake portal comprises a scanner.

12. The system of claim 1, wherein the intake portal captures the unique identifier present on the asset if the asset is self-validating, or creates a new unique identifier if the asset is not self-validating.

13. The system of claim 1, wherein the processor cryptographically secures the documented evidence captured by the intake portal by generating the unique digital signature of the evidence using a hashing function.

14. The system of claim 1, wherein the output of the hashing function is posted to an immutable digital asset ledger, thereby securing the integrity of the documented evidence received by the input portal.

15. The system of claim 1, wherein the asset unique identifier is saved locally and on the immutable digital asset ledger.

16. The system of claim 1, wherein the immutable digital asset ledger comprises a system inventory of multiple asset items present in the system.

17. The system of claim 1, wherein the asset unique identifier comprises the item's value denomination.

18. The system of claim 1, wherein the asset is not currency.

19. The system of claim 1, wherein at least one of the asset types is not currency.

20. The system of claim 1, further comprising a physical or digital wallet storing the cryptographically unique proof of record.

21.-69. (canceled)
